(19) United States
(12) Patent Application Publication
(10) Pub. No.: US 2026/0159785 A1
(43) Pub. Date: Jun. 11, 2026

(54) PARTICULATE FABRIC CARE COMPOSITION

(71) Applicant: The Procter & Gamble Company, Cincinnati, OH (US)

(72) Inventors: Gang SI, Newcastle upon Tyne (GB); Michael MCDONNELL, Blyth (GB); Trudie Jane MCCARTHY, Newcastle upon Tyne (GB); Pu ZHAO, Beijing (CN); Clemens LIEDEL, Frankfurt am Main (DE); Carsten SCHAEFER, Frankfurt (DE); Hiroe YAMADA, Frankfurt am Main (DE)

(21) Appl. No.: 19/178,111

(22) Filed: Apr. 14, 2025

(30) Foreign Application Priority Data
Apr. 19, 2024 (WO) PCT/CN2024/088829

(51) Int. Cl. C11D 17/00; C11D 3/00; C11D 3/37; C11D 3/50

(52) U.S. Cl. CPC C11D 17/0065; C11D 3/0036; C11D 3/3715; C11D 3/50; C11D 2111/12

(57) ABSTRACT

The fabric care product including a plurality of particles. Each particle of the plurality of particles includes: from 25% to 99%, by weight of the particle, a water-soluble carrier; and from 1.0% to 75%, by weight of the particle, an anionic soil release polyester. The anionic soil release polyester includes: (i) at least one terephthalate structural unit, (ii) at least one 5-sulfoisophthalate structural unit, (iii) at least one alkylene glycol structural unit, and (iv) at least one polyalkylene glycol structural unit.

### TECHNICAL FIELD

The invention relates to a fabric care product comprising a plurality of particles, where the particles comprise a water-soluble carrier and a specific anionic soil release polyester.

### BACKGROUND

Soil release polymers are known and used in fabric and home care formulations. In the washing process, a soil release polymer can deposit on fibers, which change the surface properties of fabric and deliver various benefits, such as reduced soil deposition onto fabric during wash and wear; reduced adhesion of microorganism and allergens onto fabric; easier soil removal from fabrics which treated with soil release polymer in previous wash; reduced malodor; improved wicking properties.

Laundry detergent composition comprising polyester soil release polymers are known. The chemical stability of polyester soil release polymer in liquid composition is often a challenge due to hydrolysis of the ester bonds within polyester soil release polymers in liquid composition. Water content, pH, amine (such as triethanolamine) content are known to impact the stability of polyester soil release polymers in liquid detergent composition.

Polyester soil release polymers are more stable in powder detergent, but for liquid consumers, it is not common for them to combine a powder detergent with a liquid detergent during within one wash. Therefore, to bring various benefit related soil release polymer to liquid detergent consumers, there is a need to develop through the wash laundry care additive composition comprising soil release polymers.

The inventors have surprisingly found specific anionic soil release polyester are biodegradable and can be incorporated into a particle that comprises specific water-soluble carrier. Said soil release polyester show good compatibility with the specific making process of the particle. The particles show fast and complete dissolution into water, good appearance, and good storage stability. Through the wash laundry care product comprising the particle show good on cleaning when used in combination with a detergent composition, particularly a liquid detergent composition.

### SUMMARY

In one aspect, the present invention is related to a fabric care product comprising a plurality of particles, wherein the particles comprise: from 25% to 99%, by weight of the particle, a water-soluble carrier; and from 1.0% to 75%, by weight of the particle, an anionic soil release polyester; wherein the anionic soil release polyester comprises:
(i) at least one terephthalate structural unit,
(ii) at least one 5-sulfoisophthalate structural unit,
(iii) at least one alkylene glycol structural unit, and
(iv) at least one polyalkylene glycol structural unit,
wherein the weight percentage of polyalkylene glycol structural units (in relative to the anionic soil release polyester) is in the range from 35 to 95 wt. %, preferably from 55 to 90 wt. %, even preferably from 58 to 85 wt. %, more preferably from 60 to 80 wt. %, and
wherein the particle has a mass of from 5.0 mg to 1.0 g; the particle has a longest dimension of at least 3.0 mm; and the particle has an aspect ratio of from 1.1 to 5.0.

In some embodiments, the anionic soil release polyester comprises at least one terephthalate structural unit (A), at least one 5-sulfoisophthalate structural unit (B), at least one alkylene glycol structural unit (C), at least one first polyalkylene glycol structural unit (D), and optionally, if present at least one second polyalkylene glycol structural unit (E),

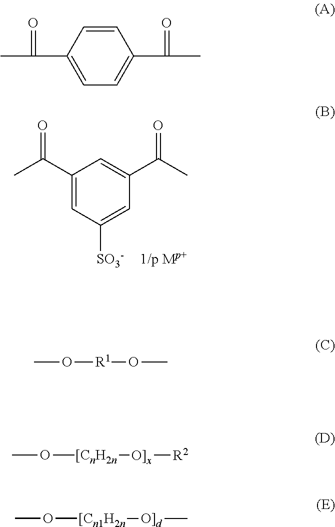

wherein
1/p M^{P+} is a cation, preferably selected from the group consisting of monovalent cations M+(p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H,
R¹ is a linear or branched alkylene group represented by the formula (CₘH₂ₘ) wherein m is an integer from 2 to 12, preferably from 2 to 6, more preferably from 2 to 4 and even more preferably from 2 to 3, most preferably 3,
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃,
n is 2 or an integer >2, preferably is an integer from 2 to 12, more preferably is an integer from 2 to 6 and even more preferably is an integer from 2 to 4, whereby the definition of n may vary within a single structural unit (D),
x is, based on molar average, a number of at least 2, preferably a number from 2 to 200, more preferably from 2 to 180, more preferably from 3 to 150, even more preferably from 4 to 115, particularly preferably from 5 to 90 and extraordinarily preferably from 6 to 70,
n1 is 2 or an integer >2, preferably is an integer from 2 to 12, more preferably is an integer from 2 to 6 and even more preferably is an integer from 2 to 4, and wherein, the definition of n1 may vary within a single structural unit (E),
d is, based on molar average, 2 or a number >2, preferably a number from 2 to 200, preferably from 3 to 150, more preferably from 4 to 100, particularly preferably from 4 to 50 and extraordinarily preferably from 5 to 25,
   wherein the total weight percentage of polyalkylene glycol structural units in structural unit (D) and/or (E) (in relative to the anionic soil release polyester) is in the range from 35 to 95 wt. %, preferably from 55 to 90 wt. %, preferably from 58 to 85 wt. %, more preferably from 60 to 80 wt. %.

In some preferred embodiment, x is, based on molar average, a number of at least 2, preferably a number from 2 to 200, more preferably from 2 to 180, more preferably from 3 to 150, more preferably from 4 to 120, more preferably from 4 to 115.

In another preferred embodiment, x is, based on molar average, a number of from 30 to 115, preferably from 55 to 115, more preferably from 65 to 115.

In some referred embodiments, the anionic soil release polyester comprises one or more terephthalate structural units (A), one or more 5-sulfoisophthalate structural units (B), one or more alkylene glycol structural units (C), one or more first polyalkylene glycol structural units (D), wherein in structural unit (C) and (D),
R¹ is a linear or branched alkylene group represented by the formula (CₘH₂ₘ) wherein m is an integer selected from 2 to 3, preferably 3.
x is, based on molar average, a number of at least 30, preferably from 30 to 200, more preferably from 40 to 180, even more preferably from 50 to 150, particularly preferably from 60 to 120 and extraordinarily preferably from 65 to 115.

In some preferred embodiments, in the one or more first polyalkylene glycol structural units (D),
x is, based on molar average, a number of at least at least 55, preferably from 55 to 200, more preferably from 55 to 180, even more preferably from 55 to 150, particularly preferably from 60 to 120 and extraordinarily preferably from 65 to 115.

In some preferred embodiments, in the one or more second polyalkylene glycol structural unit (E),
n1 is an integer from 2 to 4, preferably from 2 to 3, wherein the definition of n1 may vary within a single structural unit (E)
d is, based on molar average, 2 or a number >2, preferably a number from 2 to 200, preferably from 3 to 150, more preferably from 4 to 100, particularly preferably from 4 to 50 and extraordinarily preferably from 5 to 25.

In a more preferred embodiment, the anionic soil release polyester comprises first polyalkylene glycol structural unit (D), wherein
R² is a linear C₁-C₆ alkyl group and even more preferably CH₃,
n is an integer from 2 to 4, and
x is, based on molar average, a number from 2 to 200, preferably from 4 to 180, preferably from 50 to 150, particularly preferably from 60 to 120 and extraordinarily preferably from 65 to 115.

In a more preferred embodiment, the second polyalkylene glycol structural unit (E) of the anionic soil release polyester has a structure of formula (E-a)

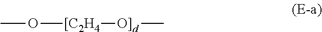

wherein d is, based on molar average, a number from 2 to 200, preferably from 3 to 150, more preferably from 4 to 100, particularly preferably from 4 to 50 and extraordinarily preferably from 5 to 25.

In some embodiments, the water-soluble carrier present in the particles of the present invention is selected from the group consisting of polyalkylene glycol, inorganic alkali metal salt, inorganic alkaline earth metal salt, organic alkali metal salt, organic alkaline earth metal salt, carbohydrates and derivatives thereof, clay, zeolites, citric acid, fatty alcohol, glycerol, glyceryl diester of hydrogenated tallow, water-soluble polymers, and combinations thereof; preferably wherein the polyalkylene glycol is selected from polyethylene glycol, polypropethylene glycol, ethylene oxide/propylene oxide block copolymers, and combinations thereof, more preferably the water-soluble carrier is polyethylene glycol having a weight average molecular weight from 2000 to 20000 Da; preferably wherein the water-soluble carrier is selected from polyethylene glycol, sodium sulfate, sodium chloride, sodium bicarbonate, sodium acetate, sodium silicate, starch, modified starch, cellulose, clay, zeolites, silica, PVA, and derivative thereof, and any combination thereof. Preferably, the particle of the present invention can further comprise other fabric care active agents, selected from the group consisting of surfactants, perfume ingredients, antioxidants, enzyme, fabric softener active such as quaternary ammonium compound or silicone, cationic polymer, fatty acid, and mixtures thereof.

The fabric care product of the present invention may preferably consist of the particle described herein. Alternatively, the fabric care product of the present invention comprises the particles described herein with, preferably the particle is present in the range of from 0.1% to 99% by weight of the fabric care product. The fabric care product of the present invention may further comprise additional fabric care active agents. The additional fabric care active agents can be composed in the particle or present in the fabric care product in a solid form.

In another aspect, the present invention provides a process for making particles described herein, comprising the steps of: providing a mixture of molten water-soluble carrier, an anionic soil release polyester, and optionally other materials; and cooling down the molten mixture on the moving conveyor to form a plurality of solid particles.

In another aspect, the present invention also relates to a process for treating laundry with the fabric care product containing the particles described herein, said process comprises the steps of:
providing laundry in a washing machine;
dispensing said fabric care product into said washing machine;
contacting said laundry with water;
dissolving said fabric care product in said water to form a laundry treatment liquor; and
contacting said laundry with said laundry treatment liquor.

These and other aspects of the present invention will become more apparent upon reading the following detailed description of the invention.

### BRIEF DESCRIPTION OF THE DRAWINGS

While the specification concludes with claims particularly pointing out and distinctly claiming the invention, it is believed that the invention will be better understood from the following description of the accompanying figures in which like reference numerals identify like elements, and wherein:

FIG. 1 shows image photos of dissolution test results for the Inventive Examples of the present invention vs. Comparative Examples.

### DETAILED DESCRIPTION

Features and benefits of the various embodiments of the present invention will become apparent from the following description, which includes examples of specific embodiments intended to give a broad representation of the invention. Various modifications will be apparent to those skilled in the art from this description and from practice of the invention. The scope of the present invention is not intended to be limited to the particular forms disclosed and the invention covers all modifications, equivalents, and alternatives falling within the spirit and scope of the invention as defined by the claims.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

As used herein, terms such as “a” and “an” when used in a claim, are understood to mean one or more of what is claimed or described. The terms “comprise,” “comprises,” “comprising,” “contain,” “contains,” “containing,” “include,” “includes” and “including” are all meant to be non-limiting.

The term “perfume-containing particle” refers to a particle comprising one or more perfume ingredients, such as free perfumes, pro-perfumes, encapsulated perfumes (including perfume microcapsules), and the like. Preferably, such perfume-containing particles contain perfumes encapsulated in perfume microcapsules, especially friable perfume microcapsules.

The term “aspect ratio” refers to the ratio of the longest dimension of the particles over its shortest dimension. For example, when such particles have a hemispherical or compressed hemispherical shape, the aspect ratio is the ratio between the base diameter of the particles over its height.

Further, the term “substantially free of” or “substantially free from” means that the indicated material is present in the amount of from 0 wt. % to about 1 wt. %, preferably from 0 wt. % to about 0.5 wt. %, more preferably from 0 wt. % to about 0.2 wt. %. The term “essentially free of” means that the indicated material is present in the amount of from 0 wt. % to about 0.1 wt. %, preferably from 0 wt. % to about 0.01 wt. %, more preferably it is not present at analytically detectable levels.

As used herein, all concentrations and ratios are on a weight basis unless otherwise specified. All temperatures herein are in degrees Celsius (° C.) unless otherwise indicated. All conditions herein are at 20° C. and under the atmospheric pressure, unless otherwise specifically stated. All polymer molecular weights are determined by weight average number molecular weight unless otherwise specifically noted.

Since there are many tasks to be accomplished in laundering clothes such as, cleaning, stain removal, brightness, fabric restoration, softness, scent, static control, and the like, one could in theory provide a separate product for each task to be done and the consumer could completely customize the kind and amount of each benefit agent that is applied in the wash. This could become overly complicated for the consumer and require the consumer to dispense and store multiple products in his or her laundering area and combine in the optimal quantities. There are thought to be particular combinations of tasks and benefits to be obtained that the consumer might like to have available in a single product for which the dose can be customized by the consumer.

The fabric care product described herein can provide for a through the wash particulate fabric care product that is convenient for the consumer to dose to the washing machine. The through the wash particulate fabric care product can be provided in a package comprising particles. The particles described herein can be water-soluble particles. The particles can be provided in a container that is separate from the package of detergent composition. Providing the particulate fabric care particles in a container separate from the package of detergent composition can be beneficial since it allows the consumer to select the amount of fabric care composition independent of the amount of detergent composition used. This can give the consumer the opportunity to customize the amount of fabric care composition used and thereby the amount of fabric care benefit they achieve, which is a highly valuable consumer benefit.

Particulate products, especially particulates that are not dusty, are preferred by many consumers. Particulate products can be easily dosed by consumers from a package directly into the washing machine or into a dosing compartment on the washing machine. Or the consumer can dose from the package into a dosing cup that optionally provides one or more dosing indicia and then dose the particulates into a dosing compartment on the washing machine or directly to the drum. For products in which a dosing cup is employed, particulate products tend to be less messy than liquid products.

In one aspect, the present invention provides a fabric care product comprising a plurality of particles, wherein the particles comprise:
from 25% to 99%, by weight of the particle, a water-soluble carrier; and
from 1.0% to 75%, by weight of the particle, an anionic soil release polyester;
wherein the anionic soil release polyester comprises:
   (i) at least one terephthalate structural unit,
   (ii) at least one 5-sulfoisophthalate structural unit,
   (iii) at least one alkylene glycol structural unit, and
   (iv) at least one polyalkylene glycol structural unit,
wherein the weight percentage of polyalkylene glycol structural units (in relative to the anionic soil release polyester) is in the range from 35 to 95 wt. %, and
wherein the particle has a mass of from 5.0 mg to 1.0 g;
wherein the particle has a longest dimension of at least 3.0 mm; and
wherein the particle has an aspect ratio of from more than 1.1 to less than 5.0.

In some preferred embodiments, the particle in the fabric care product has a mass from 5 mg to 500 mg; preferably has a mass from 5 mg to 450 mg, preferably from 10 mg to 200 mg, and more preferably from 15 mg to 150 mg.

In some preferred embodiments, the particle in the fabric care product has a maximum dimension of more than about 3 mm and less than about 10 mm, e.g., a maximum dimension of more than 3 mm and less than 9.5 mm, preferably from 3 mm to 9 mm, more preferably from 3 mm to 8 mm. In some embodiments, the particle may have a volume from about 0.003 cm³ to about 0.15 cm³, preferably from about 0.005 cm³ to about 0.12 cm³.

Each of the particles preferably has a shape selected from the group consisting of hemispherical, compressed hemispherical, heightened hemispherical, lentil shaped, oblong, cylindrical, disc, circular, lentil-shaped, cubical, rectangular, star-shaped, flower-shaped, and any combinations thereof.

As described herein above, “aspect ratio” refers to the ratio of the longest dimension of the particles over its shortest dimension. Each of the particles of the fabric care product in the present invention has an aspect ratio from 1.1 to 5.0. Preferably, each of the particle has an aspect ratio from 1.2 to 4.5, preferably from 1.5 to 4, preferably from 1.8 to 3.5. For example, in preferred embodiments, the aspect ratio of the particle is from 2.0 to 3.2.

Compressed hemispherical refers to a shape corresponding to a hemisphere that is at least partially flattened such that the curvature of the curved surface is less, on average, than the curvature of a hemisphere having the same radius. A compressed hemispherical pastille can have an aspect ratio (base diameter to height) of from more than 2.0 to 5.0, preferably from 2.1 to 4.5, more preferably from 2.1 to 4.

Heightened hemispherical refers to a shape corresponding to a hemisphere that is at least partially heightened such that the curvature of the curved surface is more, on average, than the curvature of a hemisphere having the same radius. A heightened hemispherical pastille can have an aspect ratio of from about more than 1.1 to less than 5.0, alternatively from about 1.2 to about 3.0, alternatively from about 1.1 to about 1.9.

Lentil shaped refers to the shape of a lentil bean. Oblong shaped refers to a shape having a maximum dimension and a maximum secondary dimension orthogonal to the maximum dimension, wherein the ratio of maximum dimension to the maximum secondary dimension is greater than about 1.2 to less than 5.0. An oblong shape can have a ratio of maximum dimension to maximum secondary dimension greater than about 1.5. An oblong shape can have a ratio of maximum dimension to maximum secondary dimension greater than about 2. Oblong shaped particles can have a maximum dimension from about 3 mm to about 6 mm, a maximum secondary dimension of from about 2 mm to about 4 mm.

In a preferred embodiment, substantially all of said particles have a substantially flat base and a height (H) measured orthogonal to said base and together said particles have a distribution of heights, wherein said distribution of heights has a mean height between 1 mm and 5 mm and a height standard deviation less than 0.3 mm.

The particles may have a density ranging from about 0.5 g/cm³ to about 1.2 g/cm³. In a preferred but not necessary embodiment of the present invention, the particle has a density lower than water, so that they can float on water. For example, such particles may have a density ranging from about 0.5 g/cm³ to about 0.98 g/cm³, preferably from about 0.7 g/cm³ to about 0.95 g/cm³, more preferably from about 0.8 g/cm³ to about 0.9 g/cm³.

Preferably, the particle has a mass from 5.5 mg to 450 mg, preferably from 10 mg to 200 mg, or from about 10 mg to about 125 mg or more preferably from about 20 mg to about 50 mg. The composition may comprise a plurality of particles, the average mass of each particle is from 8 mg to 450 mg, preferably from 10 mg to 200 mg, or from about 15 mg to about 125 mg or more preferably from about 20 mg to about 50 mg.

### Anionic Soil Release Polyester

The particle in the fabric care product of the present invention comprises 1% to 75% by weight of the particle of an anionic soil release polyester. The anionic soil release_polyester comprises:
(i) at least one terephthalate structural unit,
(ii) at least one 5-sulfoisophthalate structural unit,
(iii) at least one alkylene glycol structural unit,
(iv) at least one polyalkylene glycol structural unit,

wherein the weight percentage of polyalkylene glycol structural units (in relative to the anionic soil release polyester) is in the range from 35 to 95 wt. %, preferably from 55 to 90 wt. %, preferably from 58 to 85 wt. %, more preferably from 60 to 80 wt. %.

The terephthalate structural unit is derived from terephthalic acid and/or a derivative thereof. Herein, the term “derivative thereof” comprises, but is not limited to, salts thereof, esters thereof, anhydrides thereof, and any mixtures of the foregoing.

The 5-sulfoisophthalate structural unit is derived from 5-sulfoisophthalic acid and/or a derivative thereof. Herein, the term “derivative thereof” comprises, but is not limited to, salts thereof, esters thereof, anhydrides thereof, and any mixtures of the foregoing.

The alkylene glycol structural unit is derived from a C₂ to C₁₂ glycol, preferably ethylene glycol, propylene glycol, or mixture thereof.

The at least one polyalkylene glycol structural unit is derived from polyalkylene glycol, and/or polyalkylene glycol monoalkyl ether. Preferably, the polyalkylene glycol, and/or polyalkylene glycol monoalkyl ether comprises ethylene glycol structural units, propylene glycol structural units, and mixture thereof.

Preferably, the polyalkylene glycol is selected from polyethylene glycol and copolymer of ethylene glycol and propylene glycol, such as PO/EO/PO or EO/PO/EO tri-blocks. More preferably, the polyalklene glycol is polyethylene glycol (PEG). More examples of polyalkylene glycol (PEG) are given in description further below.

Preferably, the alkyl group in the polyalkylene glycol monoalkyl ether is a C₁-C₆ alkyl group, more preferably C₁-C₄ alkyl group, more preferably C₁ alkyl (—CH₃). More preferably, the polyalkylene glycol monoalkyl ether is polyethylene glycol monoalkyl ether. Most preferably, the polyalkylene glycol monoalkyl ether is polyethylene glycol monomethyl ether (mPEG). Polyethylene glycol monomethyl ether (mPEG) with any MW is suitable, more examples of mPEG are given in description further below. When calculate the weight percentage of polyalkylene glycol structural units (in relative to the anionic soil release polyester), the alkyl group is excluded so that only the polyalkylene glycol structural units are counted.

The anionic soil release polyester may further comprise other structural units. Suitable other structural unit may be derived from diols or diacids selected from C₆ cycloaliphatic diols, C₆ cycloaliphatic diacid and derivatives thereof, C₂ to C₁₀ aliphatic diacids and derivatives thereof, other aromatic diacids and derivatives thereof. Herein, the term “derivative thereof” comprises, but is not limited to, salts thereof, esters thereof, anhydrides thereof, and any mixtures of the foregoing.

Preferably, the anionic soil release polyester comprises at least one terephthalate structural unit (A), at least one 5-sulfoisophthalate structural unit (B), at least one alkylene glycol structural unit (C), at least one first polyalkylene glycol structural unit (D), and optionally, if present at least one second polyalkylene glycol structural unit (E).

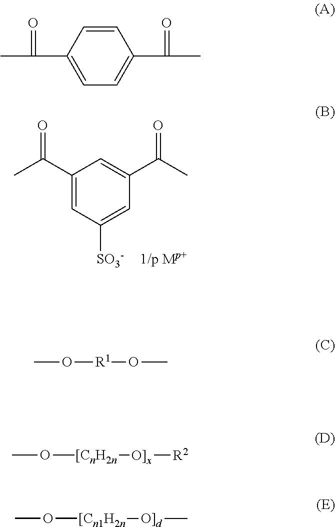

wherein
1/p M^{P+} is a cation, preferably selected from the group consisting of monovalent cations M+(p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H,
R¹ is a linear or branched alkylene group represented by the formula (CₘH₂ₘ) wherein m is an integer from 2 to 12, preferably from 2 to 6, more preferably from 2 to 4 and even more preferably from 2 to 3, most preferably 3,
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃,
n is 2 or an integer >2, preferably is an integer from 2 to 12, more preferably is an integer from 2 to 6 and even more preferably is an integer from 2 to 4, whereby the definition of n may vary within a single structural unit (D), and
x is, based on molar average, a number of at least 2, preferably a number from 2 to 200, more preferably from 2 to 180, more preferably from 4 to 150, more preferably from 4 to 120, even more preferably from 4 to 115, particularly preferably from 5 to 90 and extraordinarily preferably from 6 to 70,
n1 is 2 or an integer >2, preferably is an integer from 2 to 12, more preferably is an integer from 2 to 6 and even more preferably is an integer from 2 to 4, and wherein, the definition of n1 may vary within a single structural unit (E),
d is, based on molar average, 2 or a number >2, preferably a number from 2 to 200, preferably from 3 to 150, more preferably from 4 to 100, particularly preferably from 4 to 50 and extraordinarily preferably from 5 to 25.

Preferably, the total weight percentage of polyalkylene glycol structural units in first polyalkylene glycol structural unit (D) and/or second polyalkylene glycol (E) (in relative to the anionic soil release polyester) is in the range from 35 to 95 wt. %, preferably from 55 to 90 wt. %, preferably from 58 to 85 wt. %, more preferably from 60 to 80 wt. %.

In some preferred embodiment, x is, based on molar average, a number of at least 2, preferably a number from 2 to 200, more preferably from 2 to 180, more preferably from 3 to 150, more preferably from 4 to 120, more preferably from 4 to 115.

In another preferred embodiment, x is, based on molar average, a number of from 30 to 115, preferably from 55 to 115, more preferably from 65 to 115.

Preferably, the at least one terephthalate structural unit (A) is derived from terephthalic acid and/or a derivative thereof. Herein, the term “derivative thereof” comprises, but is not limited to, salts thereof, esters thereof, anhydrides thereof, and any mixtures of the foregoing. More preferably, the at least one structure unit (A) is derived from terephthalic acid or its dialkyl esters, preferably its (C₁-C₄)-dialkyl esters and more preferably its dimethyl ester.

Preferably, the at least one 5-sulfoisophthalate structural unit (B) is derived from 5-sulfoisophthalic acid and/or a derivative thereof. Herein, the term “derivative thereof” comprises, but is not limited to, salts thereof, esters thereof, anhydrides thereof, and any mixtures of the foregoing. Among “5-sulfoisophthalic acid and/or a derivative thereof” 5-sulfoisophthalic acid sodium salt and dimethyl-5-sulfoisophthalate sodium salt (5-SIM) are preferred.

In the case that one molecule of the anionic soil release polyesters according to the invention comprises two or more 5-sulfoisophthalate structural units (B), the definition of 1/p M^{P+} may vary between those structural units.

The amount of terephthalate structural units (A) in the polyesters of the invention is, on average, preferably from 1 to 80 mol-%, more preferably from 2 to 60 mol-%, even more preferably from 5 to 50 mol-%, particularly preferably from 10 to 40 mol-%, and extraordinarily preferably from 15 to 30 mol-%, in each case based on the combined amount of terephthalate structural units (A) and 5-sulfoisophthalate structural units (B) in the polyesters of the invention.

Preferably, the total number of terephthalate structural units (A) and 5-sulfoisophthalate structural units (B) in the polyesters of the invention is, based on molar average, from 2 to 30, more preferably from 3 to 22, even more preferably from 4 to 16 and particularly preferably from 5 to 14, such as 7, 9, 12.

Preferably, the at least one alkylene glycol structural units (C) is derived from alkylene glycol of the formula HO—R¹—OH, wherein R¹ has the meaning given above for alkylene glycol structural unit (C). Preferably, the alkylene glycol is selected from C₂-C₁₂ alkylene glycol, more preferably from C₂-C₆ alkylene glycol, even more preferably from C₂-C₄ alkylene glycol and particularly preferably from C₂-C₃ alkylene glycol.

In the case that one molecule of the polyesters of the invention comprises two or more alkylene glycol structural units (C), the definition of R¹ may vary between those structural units.

When the alkylene glycol contains three or more carbon atoms, it is the intention of the invention to cover all possible isomers of the alkylene glycol. For example, when the alkylene glycol contains three carbon atoms, it can include:

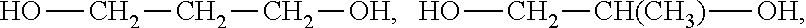

When the alkylene glycol contains 4 carbon atoms, it can include:

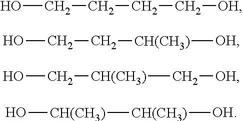

When the alkylene glycol contains three or more carbon atoms, it is also the intention of the invention to cover all possible ways in which the alkylene glycol may connect with other structural units of the polyester of the invention. For example, when the alkylene glycol is

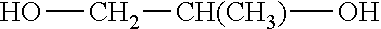

The monomer has two possible ways to connect with other structural units of the polyester of the invention:

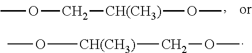

Among C₂-C₄ alkylene glycol, ethylene glycol, 1,3-propylene glycol, 1,2-propylene glycol, 1,4-butylene glycol, 1,3-butylene glycol, 2,3-butylene glycol and mixtures thereof are preferred.

Preferably, the polyester of the invention comprises one or more alkylene glycol structural units (C) wherein m is 3.

More preferably, the polyester of the invention comprises one or more alkylene glycol structural units (C) wherein m is 2 and one or more alkylene glycol structural units (C) wherein m is 3.

The one or more alkylene glycol structural units (C) wherein m is 2, preferably are derived from ethylene glycol. The one or more alkylene glycol structural units (C) wherein m is 3, preferably are derived from 1,2-propylene glycol.

Even more preferably, the at least one alkylene glycol structural units (C) are selected from the group consisting of structural units derived from ethylene glycol, structural units derived from 1,2-propylene glycol and structural units derived from mixtures of ethylene glycol and 1,2-propylene glycol, particularly preferably, the one or more alkylene glycol structural units (C) are selected from the group consisting of structural units derived from 1,2-propylene glycol and structural units derived from mixtures of ethylene glycol and 1,2-propylene glycol, and extraordinarily preferably, the one or more alkylene glycol structural units (C) are structural units derived from mixtures of ethylene glycol and 1,2-propylene glycol.

In the following, specific examples of alkylene glycol structural units (C) derived from alkylene glycol are given. The alkylene glycol structural units (C) derived from 1,2-propylene glycol have the formula (C-1)

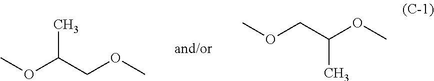

and the alkylene glycol structural units (C) derived from ethylene glycol have the formula (C-2)

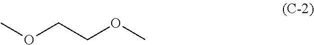

In case the polyesters of the invention comprise one or more structural units of the formula (C-1) and one or more structural units of the formula (C-2), the amount of the one or more structural units of the formula (C-1) in the polyesters of the invention is, on average, preferably from 1 to 100 mol-%, more preferably from 10 to 90 mol-%, even more preferably from 20 to 80 mol-%, particularly preferably from 30 to 70 mol-%, and extraordinarily preferably from 40 to 60 mol-%, in each case based on the combined amount of the one or more structural units of the formula (C-1) and the one or more structural units of the formula (C-2) in the polyesters of the invention.

In the case that one molecule of the polyesters of the invention comprises one or more first polyalkylene glycol structural unit (D); and/or one or more optional second polyalkylene glycol structural units (E) derived from polyalkylene glycol. The definitions of n, x, R², n1 and d, may vary between those structural units. The total weight percentage of polyalkylene glycol structural units in first polyalkylene glycol structural unit (D) and/or second polyalkylene glycol (E) (in relative to the anionic soil release polyester) is in the range from 35 to 95 wt. %, preferably from 55 to 90 wt. %, preferably from 58 to 85 wt. %, more preferably from 60 to 80 wt. %.

Preferably, the one or more first polyalkylene glycol structural unit (D) is derived from polyalkylene glycol monoalkyl ether, preferably with formula HO—[CₙH₂ₙ—O]ₓ—R², wherein n, x and R² have the meanings given above for the first polyalkylene glycol structural unit (D). Preferably, x in the one or more structural units of the formula (D) is, based on molar average, a number of at least 30, more preferably from 30 to 200, even more preferably from 40 to 180, particularly preferably from 50 to 150, extraordinarily preferably from 60 to 120 and especially preferably from 65 to 115. When making the soil release polyester, polyalkylene glycol monoalkyl ether of formula HO—[CₙH₂ₙ—O]ₓ—R², only the OH group on one side can participate into the esterification/transesterification reaction, the side with R² modification cannot participate into the reaction, therefore the first polyalkylene glycol structural unit (D) is also considered as a terminal group (D).

Preferably, n in the one or more first polyalkylene glycol structural unit (D) is 2.

Preferably, the one or more first polyalkylene glycol structural unit (D) of the polyester of the invention are selected from the formula (D-a)

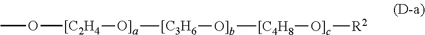

wherein
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃,
a, b and c are, based on molar average, independently of one another, numbers from 0 to 200, the sum of a+b+c is a number of at least 2, preferably at least 10, preferably from 20 to 200, more preferably from 40 to 180, even more preferably from 50 to 150, particularly preferably from 60 to 120 and extraordinarily preferably from 65 to 115, the [C₂H₄—O], [C₃H₆—O]and/or [C₄H₈—O]units of the one or more structural units of the formula (D-a) may be arranged blockwise, alternating, periodically and/or statistically, preferably blockwise and/or statistically, and either of the [C₂H₄—O], [C₃H₆—O]and [C₄H₈—O]units of the one or more structural units of the formula (D-a) can be linked to —R² and/or —O.

Any of the units [C₄H₈—O], [C₃H₆—O]and [C₂H₄—O]can be linked to R²— and —O. This means, for example, that both R²— and —O may be connected to a [C₄H₈—O]-group, they may both be connected to a [C₃H₆—O]-group, they may both be connected to a [C₂H₄—O]-group or they may be connected to different groups selected from [C₄H₈—O], [C₃H₆—O]and [C₂H₄—O].

In the case that one molecule of the polyesters of the invention comprises two or more of the structural units of the formula (D-a), the definitions of R², a, b and c, and the sum of a+b+c may vary between those structural units.

The one or more structural units of the formula (D-a) are preferably derived from substances of the formula:

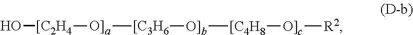

wherein R², a, b and c, and the sum of a+b+c have the meanings given above for formula (D-a).

In the one or more structural units (D-a), the sum of a+b+c preferably is a number of at least 30, more preferably from 30 to 200, even more preferably from 40 to 180, particularly preferably from 50 to 150, extraordinarily preferably from 60 to 120 and especially preferably from 65 to 115.

Preferably, “a” in the one or more structural units of the formula (D-a) is, based on molar average, a number from 2 to 200.

More preferably, “a” in the one or more structural units of the formula (D-a) is, based on molar average, a number from 30 to 200, more preferably from 40 to 180, even more preferably from 50 to 150, particularly preferably from 60 to 120 and extraordinarily preferably from 65 to 115.

More preferably, “a” in the one or more structural units of the formula (D-a) is, based on molar average, a number from 55 to 200, even more preferably from 55 to 180, particularly preferably from 55 to 150, extraordinarily preferably from 62 to 120, and especially preferably from 67 to 115.

Preferably, “b” in the one or more structural units of the formula (D-a) is, based on molar average, a number from 0 to 50, more preferably from 0 to 20, even more preferably from 0 to 10 and particularly preferably “b” is 0.

Preferably, “c” in the one or more structural units of the formula (D-a) is 0.

More preferably, “b” and “c” in the one or more structural units of the formula (D-a) are 0.

Even more preferably, in the one or more structural units (D-a)
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃,
b and c are both 0, and
a is, based on molar average, a number of from 30 to 200, preferably from 40 to 180, more preferably from 50 to 150, even more preferably from 60 to 120 and particularly preferably from 65 to 115.

In a particularly preferred embodiment of the invention, in the one or more structural units (D-a)
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group, and even more preferably CH₃,
b and c are both 0, and
a is, based on molar average, a number from 30 to 200, preferably from 40 to 180, more preferably from 50 to 150, even more preferably from 60 to 120 and particularly preferably from 65 to 115.

Even more preferably, in the one or more structural units of the formula (D-a), R² is CH₃, b and c are 0 and a is, based on molar average, a number selected from the group consisting of 3, 4, 6, 12, 16, 22, 32, 45, 56, 67, 79, 90, 102 and 113.

Examples of the one or more first polyalkylene glycol structural unit (D) or (D-a) are terminal groups derived from poly(ethylene glycol) monomethyl ether (mPEG), preferably terminal groups derived from mPEG selected from the group consisting of mPEG200, mPEG300, mPEG550, mPEG750, mPEG1000, mPEG1500, mPEG1800, mPEG2000, mPEG2500, mPEG3000, mPEG3500, mPEG4000, mPEG4500 and mPEG5000 and more preferably terminal groups derived from mPEG selected from the group consisting of mPEG2000, mPEG3000 and mPEG4000.

The number in the terms beginning with “mPEG” from the previous paragraph describes the average molecular weight of the poly(ethylene glycol) monomethyl ether in g/mol.

In a preferred embodiment of the invention, the polyester of the invention, which is hereinafter referred to as “polyester A” comprises, and preferably consists of one or more terephthalate structural units (A), and one or more 5-sulfoisophthalate structural units (B), and one or more alkylene glycol structural units (C), and one or more structural units (D-a) wherein
R² is a linear or branched C₁-C₃₀ alkyl group, a cycloalkyl group with 5 to 9 carbon atoms or a C₆-C₃₀ arylalkyl group, preferably a linear or branched C₁-C₃₀ alkyl group, more preferably a linear C₁-C₆ alkyl group and even more preferably CH₃, and
a, b and c are, based on molar average, independently of one another, numbers from 0 to 200, the sum of a+b+c is a number of at least 30, preferably from 30 to 200, more preferably from 40 to 180, even more preferably from 50 to 150, particularly preferably from 60 to 120 and extraordinarily preferably from 65 to 115, the [C₂H₄—O], [C₃H₆—O]and/or [C₄H₈—O]units of the one or more structural units of the formula (D-a) may be arranged blockwise, alternating, periodically and/or statistically, preferably blockwise and/or statistically, and either of the [C₂H₄—O], [C₃H₆—O]and [C₄H₈—O]units of the one or more structural units of the formula (D-a) can be linked to —R² and/or —O.

Preferably, in the “polyester A”
a, b and c are, based on molar average, independently of one another, numbers from 0 to 200, the sum of a+b+c is a number of at least 30, preferably from 30 to 200, more preferably from 40 to 180, even more preferably from 50 to 150, particularly preferably from 60 to 120 and extraordinarily preferably from 65 to 115, the [C₂H₄—O], [C₃H₆—O]and/or [C₄H₈—O]units of the one or more structural units of the formula (D-a) may be arranged blockwise, alternating, periodically and/or statistically, preferably blockwise and/or statistically, and either of the [C₂H₄—O], [C₃H₆—O]and [C₄H₈—O]units of the one or more structural units of the formula (D-a) can be linked to —R² and/or —O.

If exist, the one or more additional second polyalkylene glycol structural units (E) is defined as below:

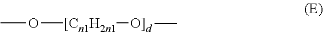

wherein
n1 is 2 or an integer >2, preferably is an integer from 2 to 12, more preferably is an integer from 2 to 6 and even more preferably is an integer from 2 to 4,
d is, based on molar average, a number from 2 to 200, preferably from 3 to 150, more preferably from 4 to 100, particularly preferably from 4 to 50 and extraordinarily preferably from 5 to 25.
   and whereby the definition of n1 may vary within a single structural unit (E), and the average number of moles of the one or more second polyalkylene glycol structural units (E) per mole of the polyester preferably is 0.3 or more than 0.3.

In the case that one molecule of the polyesters of the invention comprises two or more of the second polyalkylene glycol structural units (E), the definitions of n1 and d may vary between those structural units.

Herein, the second polyalkylene glycol structural units (E) are specifically defined to be different versus the first polyalkylene glycol structural unit (D). The one or more second polyalkylene glycol structural units (E) are derived from polyalkyleneglycol of the formula HO—I[Cₙ₁H₂ₙ₁—O]_{d}—H, wherein n1 and d have the meanings given above for formula (E). In formula HO—[Cₙ₁H₂ₙ₁—O]_{d}—H, both OH groups at the two ends are open to form esters, this is different versus structural (D-b) where only one OH group is open to form esters, the other OH is connected to R² and not open to form esters.

The term “polyalkyleneglycol” includes the homopolymers of alkylene oxide (including but not limited to ethylene oxide (EO), propylene oxide (PO) and/or butylene oxide (BO)); or the copolymers of alkylene oxide (including but not limited to ethylene oxide, propylene oxide and/or butylene oxide). When the polyalkyleneglycol is a copolymer, the different types of alkylene oxide may be arranged blockwise, alternating, periodically and/or statistically. Preferably, the polyalkyleneglycol is a homopolymer, preferably a homopolymer of ethylene oxide, or a block copolymer. Preferred polyalkyleneglycol block copolymers are EO/PO di-block, EO/PO/EO tri-block, PO/EO/PO tri-block.

Preferably, the one or more second polyalkylene glycol structural units (E) are selected from the formula (E-a)

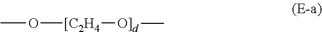

wherein d is, based on molar average, a number from 2 to 200, preferably from 3 to 150, preferably from 4 to 100, more preferably from 4 to 50, and even more preferably from 5 to 25, and the average number of moles of the one or more structural units of the formula (E-a) per mole of the polyester preferably is 0.3 or more than 0.3.

In the case that one molecule of the polyester of the invention comprises two or more of the structural units of the formula (E-a), the definition of d may vary between those structural units.

The one or more structural units of the formula (E-a) preferably are derived from polyethylene glycol of the formula HO—[C₂H₄—O]_{d}—H, wherein d has the meaning given above.

Particularly preferably, in the one or more structural units of the formula (E-a), d is, based on molar average, a number selected from the group consisting of 4, 6, 9, 11, 22, 34, 45, 56, 68, 79 and 91.

Examples of the one or more structural units of the formula (E) or (E-a) are structural units derived from polyethylene glycol, also refer as poly(ethylene glycol), (PEG) and preferably are structural units derived from PEG selected from the group consisting of PEG200, PEG300, PEG400, PEG500, PEG1000, PEG1500, PEG2000, PEG2500, PEG3000, PEG3500 and PEG4000.

The number in the terms beginning with “PEG” from the previous paragraph describes the average molecular weight of the poly(ethylene glycol) in g/mol.

The average number of moles of the one or more second polyalkylene glycol structural units (E), preferably selected from the structural units of the formula (E-a), per mole of the polyester of the invention, preferably is 0.3 or more than 0.3, more preferably is 0.5 or more than 0.5, even more preferably is 0.7 or more than 0.7, particularly preferably is 1 or more than 1 and extraordinarily preferably is 1.

When calculating the average number of moles of the one or more second polyalkylene glycol structural units (E), preferably selected from the structural units of the formula (E-a), per mole of the polyester of the invention, only structural units different from structural units derived from mono alkylene glycols are considered.

In the polyesters of the invention, the one or more second polyalkylene glycol structural units (E), preferably structural units (E-a), are not linked directly to a linear or branched C₁-C₃₀ alkyl group, a cycloalkyl group with 5 to 9 carbon atoms or a C₆-C₃₀ arylalkyl group.

In a further embodiment of the invention, the polyester of the invention comprises one or more structural units which are derived from dicarboxylic acids and/or derivatives thereof and different from the one or more terephthalate structural units (A) and 5-sulfoisophthalate structural unis (B). In case the polyester of the invention comprises such one or more structural units which are derived from dicarboxylic acids and/or derivatives thereof and different from the one or more terephthalate structural units (A) and 5-sulfoisophthalate structural unis (B), these structural units preferably are derived from substances selected from the group consisting of phthalic acid, isophthalic acid, 3-sulfophtahlic acid, 4-sulfophtahlic acid, naphthalene-1,4-dicarboxylic acid, naphthalene-2,6-dicarboxylic acid, tetrahydrophthalic acid, diphenoxyethane-4,4′-dicarboxylic acid, diphenyl-4,4′-dicarboxylic acid, 2,5-furandicarboxylic acid, adipic acid, sebacic acid, decan-1,10-dicarboxylic acid, fumaric acid, succinic acid, 1,4-cyclohexanedicarboxylic acid, cyclohexanediacetic acid, glutaric acid, azelaic acid, and/or derivatives thereof and mixtures thereof. Herein, the term “derivative thereof” comprises, but is not limited to, salts thereof, esters thereof, anhydrides thereof, and any mixtures of the foregoing. In case the aforementioned one or more structural units which are derived from dicarboxylic acids and/or derivatives thereof and different from the one or more terephthalate structural units (A) and 5-sulfoisophthalate structural unis (B) comprise a sulfo group, this sulfo group is of the formula —SO₃⁻ 1/p M^{P+}, wherein the cation 1/p M^{P+} preferably has the meaning given above, and more preferably is Na⁺.

Typically, such one or more structural units which are derived from dicarboxylic acids and/or derivatives thereof and different from the one or more terephthalate structural units (A) and 5-sulfoisophthalate structural unis (B) would be present to a minor extent, preferably in an amount smaller than 5 wt. %, based on the total weight of the polyester of the invention.

In case the polyester of the invention comprises one or more structural units which are derived from dicarboxylic acids and/or derivatives thereof and different from the one or more terephthalate structural units (A) and 5-sulfoisophthalate structural unis (B), these structural units are preferably derived from substances selected from the group consisting of isophthalic acid, 1,4-cyclohexanedicarboxylic acid, 2,5-furandicarboxylic acid, derivatives thereof and mixtures of the aforementioned.

In a further preferred embodiment of the invention, the polyester of the invention comprises one or more anionic terminal groups of the formulae

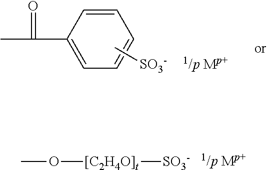

wherein,
1/p M^{P+} is a cation, preferably selected from the group consisting of monovalent cations M+(p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H, and
t is, based on molar average, a number from 1 to 10, preferably from 1 to 4, and more preferably t is 1.

In a further embodiment of the invention, the polyester of the invention comprises crosslinking structural units derived from one or more crosslinking agents. Herein, the crosslinking agent is defined as an organic molecule which comprises three or more functional groups selected from carboxylic acid group; salts, esters, or anhydrides of carboxylic acid (whereby an anhydride group of carboxylic acids is equivalent to two carboxylic acid groups); hydroxyl group; and any mixture thereof. Examples of crosslinking agents comprise, but are not limited to, citric acid (contains 3 carboxylic acid groups and 1 hydroxyl group), trimellitic acid (contains 3 carboxylic acid groups), glycerol (contains 3 hydroxyl groups), and sugar alcohols such as sorbitol, mannitol, erythritol, etc.

Typically, such crosslinking structural units would be present to a minor extent, preferably in an amount smaller than 5 wt. %, more preferably in an amount smaller than 3 wt.-%, and even more preferably in an amount smaller than 1 wt. %, in each case based on the total weight of the polyester of the invention.

Preferably, in the polyester of the invention, the amount of the one or more terminal groups (D), preferably selected from the terminal groups of the formula (D-a), is, in each case based on the total weight of the polyester, at least 40 wt. %, more preferably at least 50 wt. %, more preferably in the range from 55 to 90 wt. %, preferably from 58 to 85 wt. %, more preferably from 60 to 80 wt. %.

Preferably, in the polyester of the invention, the combined amount of the one or more terephthalate structural units (A), and the one or more 5-sulfoisophthalate structural units (B), and the one or more alkylene glycol structural units (C), and the one or more first polyalkylene glycol structural unit (D), preferably selected from (D-a), and, if present, the one or more structural units (E), preferably selected from the structural units of the formula (E-a), is at least 50 wt. %, more preferably is at least 60 wt. % and even more preferably is at least 70 wt. %, in each case based on the total weight of the polyester.

In a preferred embodiment of the invention, the polyester of the invention consists exclusively of the one or more terephthalate structural units (A), and of the one or more 5-sulfoisophthalate structural unis (B), and of the one or more alkylene glycol structural units (C), and of the one or more first polyalkylene glycol structural units (D), preferably selected from (D-a), and, if present, of the one or more second polyalkylene glycol structural units (E), preferably selected from the structural units of the formula (E-a).

In a more preferred embodiment of the invention, the polyester of the invention consists exclusively of the one or more terephthalate structural units (A), and of the one or more 5-sulfoisophthalate structural unis (B), and of the one or more alkylene glycol structural units (C), and of the one or more first polyalkylene glycol structural units (D), preferably selected from (D-a).

In another more preferred embodiment of the invention, the polyester of the invention consists exclusively of the one or more terephthalate structural units (A), and of the one or more 5-sulfoisophthalate structural unis (B), and of the one or more alkylene glycol structural units (C), and of the one or more first polyalkylene glycol structural units (D), preferably selected from (D-a), and of the one or more second polyalkylene glycol structural units (E), preferably selected from (E-a).

When no cross-linking agent is used for the preparation of the polyesters of the invention, polyesters are formed which possess a linear structure and contain a terminal group (D) at one end of the polyester or a terminal group (D) at both ends of the polyester. Preferably, the polyester of the invention possesses a linear structure, i. e. does not comprise cross-linking structures, and contains a terminal group (D) at both ends of the polyester. When a cross-linking agent is used for the preparation of the polyesters of the invention, the respective polyesters may comprise more than 2 terminal groups (D).

In case the polyester of the invention contains only one terminal group (D), the polyester of the invention comprises one or more further terminal groups different from (D). These terminal groups may result from other reactants used for the preparation of the polyester. Preferably, these terminal groups are selected from the group consisting of —OH, —OCH₃ (these two terminal groups can e. g. occur in case a structural unit (A) or (B) terminates an end of the polyester), —O—CH(CH₃)—CH₂—OH, —O—CH₂—CH(CH₃)—OH (these terminal groups can e. g. occur in case a alkylene glycol structural unit (C) terminates an end of the polyester), —O—[Cₙ₁H₂ₙ₁—O]_{d}H, wherein n1 and d have the meanings given above for formula (E) and whereby the definition of n1 may vary within a single terminal group (this terminal group can e. g. occur in case a second polyalkylene glycol structural unit (E) terminates an end of the polyester).

In a further preferred embodiment of the invention, the polyester of the invention has the formula (X)

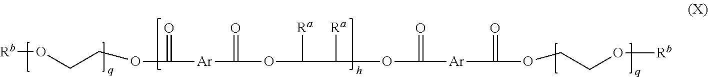

wherein
R^{a} is, each independently, selected from the group consisting of H and CH₃, whereby the polyester comprises one or more structural units —O—CHR^{a}—CHR^{a}—O— wherein one of the two residues R^{a} is H and the other of the two residues R^{a} is CH₃, preferably, the one or more structural units —O—CHR^{a}—CHR^{a}—O— are selected from the group consisting of —O—CH₂—CH₂—O—, —O—CH₂—CH(CH₃)—O—, —O—CH(CH₃)—CH₂—O— and mixtures thereof, whereby the polyester comprises one or more structural units —O—CHR^{a}—CHR^{a}—O— wherein one of the two residues R^{a} is H and the other of the two residues R^{a} is CH₃, and more preferably, the one or more structural units —O—CHR^{a}—CHR^{a}—O— are mixtures of one or more structural units —O—CH₂—CH₂—O— and one or more structural units —O—CHR^{a}—CHR^{a}—O— wherein one of the two residues R^{a} is H and the other of the two residues R^{a} is CH₃,
R^{b} is, each independently, a linear C₁-C₆ alkyl group, more preferably CH₃,
q is, based on molar average, each independently, a number of at least 30, preferably from 30 to 200, more preferably from 40 to 180, even more preferably from 50 to 150, particularly preferably from 60 to 120 and extraordinarily preferably from 65 to 115,
Ar represents, each independently

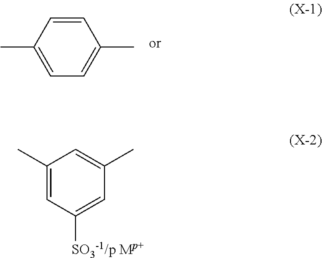

the polyester comprising both, one or more structural units of the formula (X-1) and one or more structural units of the formula (X-2),
1/p M^{P+} is a cation, preferably selected from the group consisting of monovalent cations M⁺ (p=1), divalent cations ½ M²⁺ (p=2) and trivalent cations ⅓ M³⁺ (p=3) and more preferably selected from the group consisting of H⁺, Li⁺, Na⁺, K⁺, ½ Mg²⁺, ½ Ca²⁺, ⅓ Al³⁺, NH₄⁺ and R^{a}R^{b}R^{c}R^{d}N⁺, wherein R^{a}, R^{b}, R^{c} and R^{d}, independently of one another, are H, linear or branched, preferably linear, (C₁-C₂₂)-alkyl groups or linear or branched, preferably linear, (C₂-C₁₀)-hydroxyalkyl groups, and wherein in the cations R^{a}R^{b}R^{c}R^{d}N⁺ at least one of R^{a}, R^{b}, R^{c} and R^{d} is not H, and
h is, based on molar average, a number from 1 to 29, preferably from 2 to 21, more preferably from 4 to 15 and even more preferably from 5 to 13.

In a preferred embodiment of the invention, “q” in the inventive polyesters of the formula (X) is, based on molar average, each independently, a number of at least 30, more preferably from 30 to 200, even more preferably from 40 to 180, particularly preferably from 50 to 150, extraordinarily preferably from 60 to 120 and especially preferably from 65 to 115.

Preferably, the polyesters of the invention are biodegradable. The biodegradability of polyesters is determined following the OECD 301B Ready Biodegradability CO₂ Evolution Test Guideline. In this test, the test substance is the sole carbon and energy source and under aerobic conditions microorganisms metabolize the test substance producing CO₂ or incorporating the carbon into biomass. The amount of CO₂ produced by the test substance (corrected for the CO₂ evolved by the blank inoculum) is expressed as a percentage of the theoretical amount of CO₂ (ThCO₂) that could have been produced if the organic carbon in the test substance was completely converted to CO₂. The polyesters of the present invention show biodegradability of more than 40%, preferably more than 50%, more preferably more than 60% within 60 days, preferably within 28 days.

It is to be understood that the polyesters of the invention are typically prepared by polycondensation processes. This leads to statistically determined mixtures of polyesters in which a mixture of molecular species with a distribution around a molar average is obtained. Furthermore, small amounts of polyester may be present within the statistically determined mixtures of polyesters which do not comprise terephthalate structural units (A) or 5-sulfoisophthalate structural unis (B).

Preferably, the weight average molecular weight (MW) of the polyester of the invention is from 2000 to 20000 g/mol and more preferably from 3000 to 18000 g/mol.

The weight average molecular weight (MW) of the polyesters of the invention may be determined by gel permeation chromatography (GPC) analysis, preferably as detailed in the following: 20 μl of sample with a concentration of 1 mg/ml dissolved in tetrahydrofuran (THF)/H₂O 80:20 (v:v) is injected onto a PSS Suprema column set of two columns with the dimensions 300 mm length and 8 mm internal diameter (ID) with a porosity of 30 Å and particle size 10 μm. The detection is monitored at 235 nm on a multiple wavelength detector. The employed eluent is 1.25 g/l of disodium hydrogen phosphate dihydrate in a 45/55% (v/v) water/acetonitrile mixture. Separations are conducted at a flowrate of 1 ml/minute and 25° C. Quantification is performed by externally calibrating standard samples of different molecular weight polyethylene glycols (430 g/mol-44000 g/mol). The used SEC columns are consisting of a modified acrylate copolymer network.

The groups (C₂H₄) in the terminal groups of the formula (D-a) and the structural units of the formula (E-a) preferably are of the formula —CH₂—CH₂—. The same applies in case the structural units of the formula (E) or the terminal groups of the formula (D) comprise one or more groups (C₂H₄).

The groups (C₃H₆) in the terminal groups of the formula (D-a) preferably are of the formula —CH(CH₃)—CH₂— or —CH₂—CH(CH₃)—, i. e. of the formula:

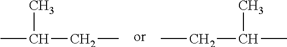

The same applies in case the structural units of the formula (E) or the terminal groups of the formula (D) comprise one or more groups (C₃H₆).

The groups (C₄H₈) in the terminal groups of the formula (D-a) preferably are of the formula —CH(CH₃)—CH(CH₃)—, i. e. of the formula

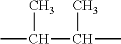

The same applies in case the structural units of the formula (E) or the terminal groups of the formula (D) comprise one or more groups (C₄H₈).

In the polyesters of the invention, the structural units or terminal groups of the formula (C), (D), (D-a), (E), or (E-a) generally are linked directly to terephthalate structural units (A) or 5-sulfoisophthalate structural unis (B). However, in the polyesters of the invention, the structural units or terminal groups of the formula (C), (D), (D-a), (E), or (E-a) generally are not linked directly to other structural units or terminal groups of the formula (C), (D), (D-a), (E), or (E-a). Likewise, in the polyesters of the invention, the structural units of the formula (A) or (B) generally are not linked directly to other structural units of the formula (A) or (B).

For the preparation of the polyesters of the invention, typically a two-stage process is used of either direct esterification of dicarboxylic acids and diols or transesterification of (i) diesters of dicarboxylic acids and (ii) diols, followed by a polycondensation reaction under reduced pressure.

A further subject matter of the invention is a process for the preparation of the polyesters of the invention, comprising the steps of heating terephthalic acid and/or a derivative thereof, preferably dimethyl terephthalate, and 5-sulfoisophthalic acid and/or a derivative thereof, preferably dimethyl-5-sulfoisophthalate sodium salt, and 1,2-propylene glycol, and one or more substances of the formula HO—[CₙH₂ₙ—O]ₓ—R² wherein n, x and R² have the meanings given above for formula (D) and whereby the definition of n may vary within a single molecule of the formula HO—[CₙH₂ₙ—O]ₓ—R², and preferably one or more substances of the formula HO—[C₂H₄—O]ₐ—[C₃H₆—O]_{b}—[C₄H₈—O]_{c}—R² wherein a, b, c, the sum of a+b+c, and R² have the meanings given above for formula (D-a) and whereby the [C₂H₄—O], [C₃H₆—O]and/or [C₄H₈—O] units of the one or more substances of the formula HO—[C₂H₄—O]ₐ—[C₃H₆—O]_{b}—[C₄H₈—O]_{c}—R² may be arranged blockwise, alternating, periodically and/or statistically, preferably blockwise and/or statistically, and either of the [C₂H₄—O], [C₃H₆—O]and [C₄H₈—O]units of the one or more substances of the formula HO—[C₂H₄—O]ₐ—[C₃H₆—O]_{b}—[C₄H₈—O]_{c}—R² can be linked to —R² and/or —OH, and, optionally, one or more substances of the formula HO—[Cₙ₁H₂ₙ₁—O]_{d}H wherein n1 and d have the meanings given above for formula (E) and whereby the definition of n1 may vary within a single molecule of the formula HO—[Cₙ₁H₂ₙ₁—O]_{d}H, preferably one or more substances of the formula HO—[C₂H₄—O]_{d}H wherein d has the meaning given above for formula (E-a), and, optionally, one or more mono alkylene glycols different from 1,2-propylene glycol, preferably ethylene glycol, with the addition of a catalyst, to temperatures of 160 to 220° C., preferably beginning at atmospheric pressure, and then continuing the reaction under reduced pressure at temperatures of from 160 to 240° C.

Reduced pressure preferably means a pressure of from 0.1 to 900 mbar and more preferably a pressure of from 0.5 to 500 mbar.

In a preferred embodiment of the process of the invention, individual components or reactants may be added at different times during the reaction process but preferably before the reaction is continued under reduced pressure at temperatures of from 160 to 240° C.

Typical transesterification and condensation catalysts known in the art can be used for the inventive process for the preparation of the polyesters of the invention, such as antimony, germanium and titanium-based catalysts. Preferably, tetraisopropyl orthotitanate (IPT) and sodium acetate (NaOAc) are used as the catalyst system in the inventive process for the preparation of the polyesters of the invention.

The polyesters of the invention may be used in substance, i. e. as granules, but may also be provided as solutions or dispersions. For the purpose of this invention, it is preferred that the anionic soil release polyester raw material comprises less than 60 wt. %, preferrable less than 50 wt. %, preferably less than 40 wt. %, preferably less than 30 wt. %, preferably less than 20 wt. %, more preferably less than 10 wt. %, most preferably less than 1% of solvent (such as water). In situation where the anionic soil release polyester raw material comprises high level of solvent, the extra process step maybe needed to remove the solvent before making the particle of this invention.

Depend on the synthesis process, the anionic soil release polyester of the invention may comprise low level of nonionic soil release polyester. Therefore, the particle may comprise anionic soil release polyester and nonionic soil release polyester.

In a further embodiment, the particle may comprise anionic soil release polyester and separate nonionic soil release polyester, suitable nonionic soil release polyesters include, for example, but are not limited to, Texcare SRN260 or TexCare SRN170 from Clariant.

The raw materials for the preparation of the polyesters of the invention can be based on fossil carbon or renewable carbon. Renewable carbon includes carbon originating from biomass, carbon capture, or chemical recycling. Preferably, the raw materials for the preparation of the polyesters of the invention are at least partly based on renewable carbon. The Renewable Carbon Index (RCI, a measure of sustainability by dividing the number of carbons derived from renewable sources by the total number of carbons in an active ingredient) of the polyesters of the invention preferably is above 40%, more preferably above 50%, even more preferably above 60%, particularly preferably from 70 to 100%, and most preferably 100%. In a preferred embodiment of the invention, all the —CH₂—CH₂—O— structural units within structural units of the formula (E-a) and (D-a), as well as all the —CH₂—CH₂—O— structural units within structural units of the formula (E) and terminal groups of the formula (D), in case these comprise one or more structural units —CH₂—CH₂—O—, are bio-based, and the polyesters of the invention have a RCI above 40%, preferably from 50 to 95% and more preferably from 60 to 85%.

The anionic soil release polyesters of the present invention possess advantageous biodegradability. The anionic soil release polyesters of the present invention show advantageous performance in compositions as described in this invention, particularly good soil release performance such as stain removal, dirty motor oil soil release performance and good dye transfer inhibition benefit. Therefore, the present invention is also related to the use of the anionic soil release polyesters on the present invention for stain removal, soil release benefit, or for dry transfer inhibition benefit.

During the use of compositions comprising the anionic soil release polyester, the anionic soil release polyester can deposit on surfaces, especially fabric surfaces which comprise synthetic fibers, such as polyester, etc. The deposition of the anionic soil release polyester of the invention gives anti-fouling properties to the fabric surfaces: various soil (including body soil, grease soil, clay, biological stains, or microorganisms) have reduced adhesion to the polyester treated fabric surfaces, so that less soil can deposit on these surfaces during wash and wear. Furthermore, when soil is attached to a fabric surface treated with anionic soil release polyester of the invention, it can be more easily removed in later washing procedures because of reduced adhesion between soil and fabric. Overall, the anionic soil release polyester of the invention can bring various benefits including reduced soil deposition onto the fabric during the washing process and during wear, reduced adhesion of microorganisms and allergens onto the fabric, whiteness maintenance, easier soil removal from fabrics which have been treated with anionic soil release polyester of the invention in a previous washing process, i.e., soil release performance, malodor reduction or control, improved or maintained wicking properties of a fabric, etc. The polymer can also reduce deposition of dyes onto treated fabrics.

### Water-Soluble Carrier

The particle in the fabric care product of the present invention comprises from 25% to 99%, by weight of the particle, a water-soluble carrier. The water-soluble carrier can be a material that is soluble in a wash liquor within a short period of time, for instance less than about 10 minutes.

The water-soluble carrier can be selected from the group consisting of polyalkylene glycol, inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, and combinations thereof.

In some embodiments, the particle comprises polyalkylene glycol water-soluble carriers. In some embodiments, the particle comprises polyalkylene glycol and at least an additional water-soluble carrier.

Preferably, the polyalkylene glycol water-soluble carrier can be materials selected from polyethylene glycol, polypropethylene glycol, ethylene oxide/propylene oxide block copolymers, and combinations thereof. For example, the water-soluble carrier can be polyethylene glycol (PEG). PEG has a relatively low cost, may be formed into many different shapes and sizes, minimizes free perfume diffusion, and dissolves well in water. The term “polyethylene glycol” or “PEG” as used herein includes homopolymers containing repeating units of ethylene oxide, random copolymers containing repeating units of ethylene oxide and propylene oxide, block copolymers containing blocks of polyethylene oxide and polypropylene oxide, and combinations thereof.

The particles can comprise about 25% to about 99% by weight of the particles of PEG. Optionally, the particles can comprise from about 35% to about 99%, optionally from about 40% to about 99%, optionally from about 50% to about 99%, optionally combinations thereof and any whole percentages or ranges of whole percentages within any of the aforementioned ranges, of PEG by weight of the respective particles. Preferably, The PEG present in the particles is characterized by a weight average molecular weight (Mw) ranging from about 2,000 to about 20,000 Daltons, optionally from about 2000 to about 15000 Da, alternatively from about 4000 to about 20000 Da, alternatively from about 4000 to about 15000 Da, alternatively from about 4000 to about 12000 Da, alternatively from about 5000 to about 11000 Da, alternatively from about 6000 to about 10000 Da, alternatively from about 7000 to about 9000 Da, alternatively combinations thereof. Suitable PEGs include homopolymers commercially available from BASF under the tradenames of Pluriol® E 8000.

Alternatively, the polyalkylene glycol water-soluble carrier can be an ethylene oxide-propylene oxide-ethylene oxide (EOx₁POyEOx₂) triblock copolymer, which preferably has an average ethylene oxide chain length of between about 2 and about 90, preferably about 3 and about 50, more preferably between about 4 and about 20 ethylene oxide units, and an average propylene oxide chain length of between 20 and 70, preferably between 30 and 60, more preferably between 45 and 55 propylene oxide units. More preferably, the ethylene oxide-propylene oxide-ethylene oxide (EOx₁POyEOx₂) triblock copolymer has a molecular weight of from about 2000 to about 30,000 Daltons, preferably from about 3000 to about 20,000 Daltons, more preferably from about 4000 to about 15,000 Daltons.

Preferably, the copolymer comprises between 10% and 90%, preferably between 15% and 50%, most preferably between 15% and 25% by weight of the copolymer of the combined ethylene-oxide blocks. Most preferably the total ethylene oxide content is equally split over the two ethylene oxide blocks. Equally split herein means each ethylene oxide block comprising on average between 40% and 60% preferably between 45% and 55%, even more preferably between 48% and 52%, most preferably 50% of the total number of ethylene oxide units, the % of both ethylene oxide blocks adding up to 100%. Some ethylene oxide-propylene oxide-ethylene oxide (EOx₁POyEOx₂) triblock copolymer improve cleaning.

Suitable ethylene oxide—propylene oxide—ethylene oxide triblock copolymers are commercially available under the Pluronic series from the BASF company, or under the Tergitol L series from the Dow Chemical Company. A particularly suitable material is Pluronic® PE 9200. Other suitable materials include Pluronic® F38, F68 and F108.

The polyalkylene glycol water-soluble carrier also included “end capped” polyalkylene glycol. Typically, polyalkylene glycol has two —OH groups at both ends of the polymer chain, “end capped” means at least one or both of the —OH groups are reacted and connected to end capping organic group different from the polyalkylene glycol. Preferably, the end capping organic group R connected to the —OH groups of the polyalkylene glycol via an ether bond (—O—R) and/or ester bond (—O—(C═O)—R), where R is a linear or branched C₁-C₃₀ alkyl group, a cycloalkyl group with 5 to 9 carbon atoms, a C₆-C₃₀ arylalkyl group, a C₆-C₃₀ alkylaryl group. More preferably, R is a linear or branched C₁-C₃₀ alkyl group, even more preferably a linear C₁-C₆ alkyl group and even more preferably a methyl (CH₃).

Examples of suitable “end capped” polyalkylene glycol include a polyethylene glycol fatty alcohol ether of formula:

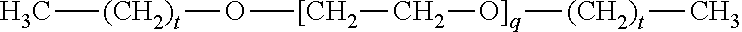

wherein
q is based on a molar average, a number from 30 to 250.
t is based on a molar average, a number from 0 to 30.

Examples of suitable “end capped” polyalkylene glycol include a polyethylene glycol fatty alcohol esters of formula:

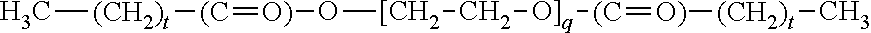

wherein
q is based on a molar average, a number from 30 to 250.
t is based on a molar average, a number from 0 to 30.

### Other Water-Soluble Carriers

The water-soluble carriers present in the particle of the present invention may also be selected from inorganic alkali metal salt, inorganic alkaline earth metal salt, organic alkali metal salt, organic alkaline earth metal salt, carbohydrates and derivatives thereof, clay, zeolites, silica, silicates, citric acid and salts thereof, fatty alcohol, glycerol, glyceryl diester of hydrogenated tallow, water-soluble polymers, etc.

Suitable inorganic alkali metal salts can be selected from the group consisting of sodium fluoride, sodium chloride, sodium bromide, sodium iodide, sodium sulfate, sodium bisulfate, sodium phosphate, sodium monohydrogen phosphate, sodium dihydrogen phosphate, sodium carbonate, sodium hydrogen carbonate, sodium silicate, potassium fluoride, potassium chloride, potassium bromide, potassium iodide, potassium sulfate, potassium bisulfate, potassium phosphate, potassium monohydrogen phosphate, potassium dihydrogen phosphate, potassium carbonate, potassium monohydrogen carbonate, potassium silicate, and combinations thereof.

Suitable inorganic alkaline earth metal salts can be selected from the group consisting of magnesium fluoride, magnesium chloride, magnesium bromide, magnesium iodide, magnesium sulfate, magnesium phosphate, magnesium monohydrogen phosphate, magnesium dihydrogen phosphate, magnesium carbonate, magnesium monohydrogen carbonate, magnesium silicate, calcium fluoride, calcium chloride, calcium bromide, calcium iodide, calcium sulfate, calcium phosphate, calcium monohydrogen phosphate, calcium dihydrogen phosphate, calcium carbonate, calcium monohydrogen carbonate, calcium silicate, and combinations thereof.

Organic salts, such as organic alkali metal salts and organic alkaline earth metal salts, contain carbon.

Suitable organic alkali metal salts can be selected from the group consisting of sodium acetate, sodium citrate, sodium lactate, sodium tartrate, sodium ascorbate, sodium sorbate, potassium acetate, potassium citrate, potassium lactate, potassium tartrate, potassium ascorbate, potassium sorbate, and combinations thereof.

Suitable organic alkali metal salts can be selected from the group consisting of calcium acetate, calcium citrate, calcium lactate, calcium tartrate, calcium ascorbate, calcium sorbate, magnesium acetate, magnesium citrate, magnesium lactate, magnesium tartrate, magnesium ascorbate, magnesium sorbate, and combinations thereof.

Carbohydrates may be selected from the group consisting of monosaccharides, disaccharides, oligosaccharides, polysaccharides and derivatives thereof, and combinations thereof.

Suitable monosaccharides may be selected from the group consisting of erythrose, ribose, arabinose, xylose, glucose, isoglucose, dextrose, galactose, mannose, erythrulose, ribulose, fructose, sorbose, rhamnose, fucose, deoxyribose, ribose, and combinations thereof.

Suitable disaccharides sugar may be selected from the group consisting of sucrose, maltose, lactose, isomaltose, trehalose, cellobiose, melibiose, gentiobiose, and combinations thereof.

Suitable oligosaccharides may be selected from the group consisting of maltotriose, raffinose, stachyose, and combinations thereof.

Preferably the sugar is selected from the group consisting of fructose, glucose, isoglucose, galactose, raffinose, and combinations thereof. More preferably the sugar comprises or is sucrose.

Suitable polysaccharides may be selected from the group consisting of homopolysaccharides, heteropolysaccharides, and combinations thereof.

Suitable polysaccharides may be selected from the group consisting of starch, corn starch, wheat starch, rice starch, potato starch, tapioca starch, modified starch, cellulose, carboxymethyl cellulose, methyl cellulose, ethyl cellulose, propyl cellulose, hydroxyethyl cellulose, hydroxypropyl cellulose, cellulose esters, cellulose amides, glycogen, pectin, dextrin, maltodextrin, corn syrup solids, alginates, xyloglugans, xylan, glucuronoxylan, arabinoxylan, mannan, dextran, glucomannan, galactoglucomannan, xanthan, carrageenan, locust bean gum, Arabic gum, tragacanth, and combinations thereof.

Carbohydrate derivatives may be selected from the group consisting of aminosugars, deoxysugars, sugar alcohols, sugar acids, and combinations thereof.

Suitable sugar alcohol may be selected from the group consisting of sorbitol, mannitol, isomalt, maltitol, lactitol, xylitol, erythritol, and combinations thereof. Preferably the sugar alcohol is selected from the group consisting of mannitol, sorbitol, xylitol and combinations thereof.

The water-soluble carrier may be selected from the group consisting of clay, zeolites, silica, silicates, citric acid and salts thereof, fatty alcohol, glyceryl diester of hydrogenated tallow, and combinations thereof.

The water-soluble carrier may be a water-soluble polymer selected from the group consisting of polyvinyl alcohols (PVA), modified PVAs; polyvinyl pyrrolidone; PVA copolymers such as PVA/polyvinyl pyrrolidone and PVA/polyvinyl amine; partially hydrolyzed polyvinyl acetate; polyglycerol esters, acrylamide; polyvinyl acetates; polycarboxylic acids and salts thereof, sulfonated polyacrylates, polyaminoacids or peptides, polyamides, polyacrylamide, copolymers of maleic/acrylic acids, gelatin, and combinations thereof.

### Other Fabric Care Active Agent

The particle in the fabric care product of the present invention can further comprise other fabric care active agents.

The fabric care product of the present invention can be consisting of a plurality of particles described herein. Alternatively, the fabric care product can comprise from 0.1% to 99% of the particle described herein. The fabric care product comprising the particles of the present invention may further comprise a fabric care active agents. The fabric care active agents can either be composed in the particle described herein or be in a solid form. The fabric care active agents in a solid form can be present as a particle of any size and shape.

Suitable fabric care active agent are selected from surfactants; enzymes and enzyme stabilizers; builders; polymers selected from graft polymers based on polyalkylene oxide, modified polyamine dispersing agent, bleaching agents, bleaching catalysts, bleach activators, fluorescent brighteners, fabric hueing agents, chelating agents, encapsulates, perfume capsules, perfumes, pro-perfumes, malodor reduction materials, conditioning agents, probiotics, organic acids, anti-oxidants, anti-microbial agents and/or preservatives, hygiene agents, pearlescent agents, pigments, solvents, suds suppressor and mixtures thereof.

Preferably, the fabric care active agent is selected from the group consisting of surfactants, perfume ingredients, antioxidants, enzyme, fabric softener active such as quaternary ammonium compound or silicone, cationic polymer, fatty acid, and mixtures thereof.

### Surfactant

The fabric care active agent can be an anionic surfactant. More preferably the surfactant comprises a combination of anionic surfactant and nonionic surfactant and most preferably the surfactant is a combination of anionic surfactant and nonionic surfactant.

Typically, the amount of surfactant is present in amount of 0.1 to 15%, more preferably 0.4 to 7% and most preferably 1 to 5% by weight of the fabric care product. The weight ratio of the water-soluble carrier to the surfactant is preferably in amount of 1:1 to 1000:1, more preferably 5:1 to 200:1 and even more preferably 15:1 to 60:1.

Examples of suitable anionic surfactants are the alkyl sulphates, alkyl ether sulphates, soap, alkaryl sulphonates, alkanoyl isethionates, alkyl succinates, alkyl sulphosuccinates, alkyl ether sulphosuccinates, N-alkyl sarcosinates, alkyl phosphates, alkyl ether phosphates, and alkyl ether carboxylic acids and salts thereof, especially their sodium, magnesium, ammonium and mono-, di- and triethanolamine salts. The alkyl and acyl groups generally contain from 8 to 18, preferably from 10 to 16 carbon atoms and may be unsaturated. The alkyl ether sulphates, alkyl ether sulphosuccinates, alkyl ether phosphates and alkyl ether carboxylic acids and salts thereof may contain from 1 to 20 ethylene oxide or propylene oxide units per molecule.

Preferred anionic surfactants comprise alkyl sulfates, alkyl ether sulfates, soap or a mixture thereof. More preferably, anionic surfactants comprise alkyl sulfates, alkyl ether sulfates, or a mixture thereof. These materials have the respective formulae R²OSO₃M and R¹O (C₂H₄O)ₓSO₃M, wherein R² is alkyl or alkenyl of from 8 to 18 carbon atoms, x is an integer having a value of from about 1 to about 10, and M is a cation such as ammonium, alkanolamines, such as triethanolamine, monovalent metals, such as sodium and potassium, and polyvalent metal cations, such as magnesium, and calcium. Most preferably R² has 12 to 14 carbon atoms, in a linear rather than branched chain.

More preferred surfactants are selected from sodium lauryl sulphate, sodium lauryl ether sulphate or a mixture thereof. Even more preferred anionic surfactants are selected from sodium lauryl sulphate and sodium lauryl ether sulphate(n)EO, (where n is from 1 to 3), and a mixture thereof; still even more preferably sodium lauryl ether sulphate(n)EO, (where n is from 1 to 3); most preferably sodium lauryl ether sulphate(n)EO where n=1.

Typically, the amount of anionic surfactant is present in amount of 0.1 to 12%, more preferably 0.3 to 6% and most preferably 0.6 to 3% by weight of the fabric care product. The weight ratio of the water-soluble carrier to the anionic surfactant is preferably in amount of 1:1 to 2000:1, more preferably 10:1 to 200:1 and even more preferably 25:1 to 100:1.

### Perfume Ingredients

The fabric care active agent may be a free perfume, a pro-perfume, an encapsulated perfume, and a combination thereof.

The particles in the fabric care product of the present invention may comprise from about 0.1 wt. % to about 20 wt. %, preferably from about 0.5 wt. % to about 15 wt. %, more preferably from about 1 wt. % to about 10 wt. % of one or more perfume ingredients, such as free perfumes, pro-perfumes, encapsulated perfumes (including perfume microcapsules), and the like.

Each particle may comprise no more than about 25%, preferably no more than about 20% (e.g., from about 0.1% to about 20%), more preferably from about 0.5% to about 15%, most preferably from about 1% to about 10%; alternatively, from about 9% to about 20%; alternatively, from about 10% to about 18%; alternatively, from about 11% to about 13%, alternatively, combinations thereof, of free perfumes by weight of such particle.

Each comprise may comprise encapsulated perfumes (i.e., perfumes carried by a carrier material such as starch, cyclodextrin, silica, zeolites or clay or in form of perfume capsules).

Preferably, the particles comprise perfume oil encapsulated in core-shell perfume capsules (PMCs), which can be friable, can be moisture activated or can release perfume via diffusion.

The core-shell capsules comprise a shell surrounding a core. The shell comprises a polymeric material. The polymeric material comprises, and preferably is, the reaction product of a biopolymer and a cross-linking agent.

The biopolymer may preferably be selected from the group consisting of a polysaccharide, a protein, a nucleic acid, a polyphenolic compound, derivatives thereof, and combinations thereof. Preferably, the biopolymer is selected from the group consisting of:
(a) a polysaccharide selected from the group consisting of chitosan, starch, modified starch, dextran, maltodextrin, dextrin, cellulose, modified cellulose, hemicellulose, chitin, alginate, lignin, gum, pectin, fructan, carrageenan, agar, pullulan, suberin, cutin, cutan, melanin, silk fibronin, derivatives thereof, and combinations thereof;
(b) a protein selected from the group consisting of gelatin, collagen, casein, sericin, fibroin, whey protein, zein, soy protein, plant storage protein (plant protein isolate, plant protein concentrate), gluten, peptide, actin, derivatives thereof, and combinations thereof;
(c) a nucleic acid selected from the group consisting of polynucleotides, RNA, DNA, derivatives thereof, and combinations thereof;
(d) a polyphenolic compound selected from the group consisting of tannins, lignans, derivatives thereof, and combinations thereof; or
(e) combinations thereof.

The cross-linking agent may be selected from the group consisting of isocyanate, polyisocyanate, acyl chlorides, acrylates, methacrylate, acrylate esters, and combinations thereof.

The particles may each comprise from about 0.1% to 20.0%, preferably from about 0.5% to about 10.0%, more preferably from about 1.0% to about 5.0%, alternatively from about 4.0% to about 7.0%, alternatively from about 5.0% to about 7.0%, alternatively combinations thereof, of perfume capsules by weight of the particles.

The particle may comprise both free perfumes and encapsulated perfumes (preferably in form of perfume capsules), e.g., at a weight ratio ranging from about 1:5 to about 5:1, alternatively from about 1:4 to about 4:1, further alternatively from about 1:3 to about 3:1.

### Antioxidant

The fabric care active agent can be an antioxidant. The particles can comprise from about 0.1% to about 2% by weight antioxidant. The antioxidant can be dispersed in a matrix of said water soluble carrier. The antioxidant can those described in U.S. Patent Application 63/034,766. The antioxidant can be butylated hydroxytoluene.

### Enzyme

The fabric care active agent can be an enzyme. Preferred enzymes provide cleaning performance and/or fabric care benefits. Examples of suitable enzymes include, but are not limited to, hemicellulases, peroxidases, proteases, cellulases, xylanases, lipases, phospholipases, esterases, cutinases, pectinases, mannanases, galactanases, pectate lyases, keratinases, reductases, oxidases, phenoloxidases, lipoxygenases, ligninases, pullulanases, tannases, pentosanases, malanases, ß-glucanases, arabinosidases, hyaluronidase, chondroitinase, laccase, and amylases, or mixtures thereof. A typical combination is an enzyme cocktail that may comprise, for example, a protease and lipase in conjunction with amylase. When present in the fabric care product, the aforementioned additional enzymes may be present at levels from about 0.00001% to about 2%, from about 0.0001% to about 1% or even from about 0.001% to about 0.5% enzyme protein by weight of the fabric care product.

Proteases. Preferably the fabric care product comprises one or more proteases. Suitable proteases include metalloproteases and serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:
(a) subtilisins (EC 3.4.21.62), especially those derived from Bacillus, such as Bacillus sp., Bacillus sp., B. lentus, B. alkalophilus, B. subtilis, B. amyloliquefaciens, B. gibsonii, B. akibaii, B. clausii and B. clarkii described in WO2004067737, WO2015091989, WO2015091990, WO2015024739, WO2015143360, U.S. Pat. No. 6,312,936B1, U.S. Pat. Nos. 5,679,630, 4,760,025, DE102006022216A1, DE102006022224A1, WO2015089447, WO2015089441, WO2016066756, WO2016066757, WO2016069557, WO2016069563, WO2016069569, WO2017/089093, WO2020/156419.
(b) trypsin-type or chymotrypsin-type proteases, such as trypsin (e.g., of porcine or bovine origin), including the Fusarium protease described in WO 89/06270 and the chymotrypsin proteases derived from Cellumonas described in WO 05/052161 and WO 05/052146.
(c) metalloproteases, especially those derived from Bacillus amyloliquefaciens described in WO07/044993A2; from Bacillus, Brevibacillus, Thermoactinomyces, Geobacillus, Paenibacillus, Lysinibacillus or Streptomyces spp. Described in WO2014194032, WO2014194054 and WO2014194117; from Kribella alluminosa described in WO2015193488; and from Streptomyces and Lysobacter described in WO2016075078.
(d) Protease having at least 90% identity to the subtilase from Bacillus sp. TY145, NCIMB 40339, described in WO92/17577 (Novozymes A/S), including the variants of this Bacillus sp TY145 subtilase described in WO2015024739, and WO2016066757.

Suitable commercially available protease enzymes include those sold under the trade names Alcalase®, Savinase®, Primase®, Durazym®, Polarzyme®, Kannase®, Liquanase®, Liquanase Ultra®, Savinase Ultra®, Liquanase® Evity®, Savinase® Evity®, Ovozyme®, Neutrase®, Everlase®, Coronase®, Blaze®, Blaze Ultra®, Blaze® Evity®, Blaze® Exceed, Blaze® Pro, Esperase®, Progress® Uno, Progress® Excel, Progress® Key, Ronozyme®, Vinzon® and Het Ultra® by Novozymes A/S (Denmark); those sold under the tradename Maxatase®, Maxacal®, Maxapem®, Properase®, Purafect®, Purafect Prime®, Purafect Ox®, FN3®, FN4®, Excellase®, Ultimase® and Purafect OXP® by Dupont; those sold under the tradename Opticlean® and Optimase® by Solvay Enzymes; and those available from Henkel/Kemira, namely BLAP (sequence shown in FIG. 29 of U.S. Pat. No. 5,352,604 with the following mutations S99D+S101 R+S103A+V104I+G159S, hereinafter referred to as BLAP), BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D); and KAP (Bacillus alkalophilus subtilisin with mutations A230V+S256G+S259N) from Kao and Lavergy®, Lavergy® Pro, Lavergy® C Bright from BASF.

Amylases. Preferably the fabric care product may comprise an amylase. Suitable alpha-amylases include those of bacterial or fungal origin. Chemically or genetically modified mutants (variants) are included. A preferred alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, DSM 9375 (U.S. Pat. No. 7,153,818) DSM 12368, DSMZ no. 12649, KSM AP1378 (WO 97/00324), KSM K36 or KSM K38 (EP 1,022,334). Preferred amylases include:
(a) variants described in WO 94/02597, WO 94/18314, WO96/23874 and WO 97/43424, especially the variants with substitutions in one or more of the following positions versus the enzyme listed as SEQ ID No. 2 in WO 96/23874: 15, 23, 105, 106, 124, 128, 133, 154, 156, 181, 188, 190, 197, 202, 208, 209, 243, 264, 304, 305, 391, 408, and 444.
(b) variants described in U.S. Pat. No. 5,856,164 and WO99/23211, WO 96/23873, WO00/60060 and WO 06/002643, especially the variants with one or more substitutions in the following positions versus the AA560 enzyme listed as SEQ ID No. 12 in WO 06/002643: 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, preferably that also contain the deletions of D183* and G184*.
(c) variants exhibiting at least 90% identity with SEQ ID No. 4 in WO06/002643, the wild-type enzyme from Bacillus SP722, especially variants with deletions in the 183 and 184 positions and variants described in WO 00/60060, which is incorporated herein by reference.
(d) variants exhibiting at least 95% identity with the wild-type enzyme from Bacillus sp.707 (SEQ ID NO:7 in U.S. Pat. No. 6,093,562), especially those comprising one or more of the following mutations M202, M208, S255, R¹⁷², and/or M261. Preferably said amylase comprises one or more of M202L, M202V, M202S, M202T, M202I, M202Q, M202W, S255N and/or R¹⁷²Q.

Particularly preferred are those comprising the M202L or M202T mutations.
(e) variants described in WO 09/149130, preferably those exhibiting at least 90% identity with SEQ ID NO: 1 or SEQ ID NO:2 in WO 09/149130, the wild-type enzyme from Geobacillus Stearophermophilus or a truncated version thereof.
(f) variants exhibiting at least 89% identity with SEQ ID NO:1 in WO2016091688, especially those comprising deletions at positions H183+G184 and additionally one or more mutations at positions 405, 421, 422 and/or 428.
(g) variants exhibiting at least 60% amino acid sequence identity with the “PcuAmyl α-amylase” from Paenibacillus curdlanolyticus YK9 (SEQ ID NO:3 in WO2014099523).
(h) variants exhibiting at least 60% amino acid sequence identity with the “CspAmy2 amylase” from Cytophaga sp. (SEQ ID NO:1 in WO2014164777).
(i) variants exhibiting at least 85% identity with AmyE from Bacillus subtilis (SEQ ID NO:1 in WO2009149271).
(j) Variants exhibiting at least 90% identity variant with the wild-type amylase from Bacillus sp. KSM-K38 with accession number AB051102.

Suitable commercially available alpha-amylases include DURAMYL®, LIQUEZYME®, TERMAMYL®, TERMAMYL ULTRA®, NATALASE®, SUPRAMYL®, STAINZYME®, STAINZYME PLUS®, FUNGAMYL® and BAN® (Novozymes A/S, Bagsvaerd, Denmark), KEMZYM® AT 9000 Biozym Biotech Trading GmbH Wehlistrasse 27b A-1200 Wien Austria, RAPIDASE®, PURASTAR®, ENZYSIZE®, OPTISIZE HT PLUS®, POWERASE® and PURASTAR OXAM® (Genencor International Inc., Palo Alto, California) and KAM® (Kao, 14-10 Nihonbashi Kayabacho, 1-chome, Chuo-ku Tokyo 103-8210, Japan). In one aspect, suitable amylases include NATALASE®, STAINZYME® and STAINZYME PLUS® and mixtures thereof.

Lipases. Preferably the fabric care product comprises one or more lipases, including “first cycle lipases” such as those described in U.S. Pat. No. 6,939,702 B1 and US PA 2009/0217464. Preferred lipases are first-wash lipases. In one embodiment of the invention the fabric care product comprises a first wash lipase.

First wash lipases includes a lipase which is a polypeptide having an amino acid sequence which: (a) has at least 90% identity with the wild-type lipase derived from Humicola lanuginosa strain DSM 4109; (b) compared to said wild-type lipase, comprises a substitution of an electrically neutral or negatively charged amino acid at the surface of the three-dimensional structure within 15 A of E1 or Q249 with a positively charged amino acid; and (c) comprises a peptide addition at the C-terminal; and/or (d) comprises a peptide addition at the N-terminal and/or (e) meets the following limitations: i) comprises a negative amino acid in position E210 of said wild-type lipase; ii) comprises a negatively charged amino acid in the region corresponding to positions 90-101 of said wild-type lipase; and iii) comprises a neutral or negative amino acid at a position corresponding to N94 or said wild-type lipase and/or has a negative or neutral net electric charge in the region corresponding to positions 90-101 of said wild-type lipase.

Preferred are variants of the wild-type lipase from Thermomyces lanuginosus comprising one or more of the T231R and N233R mutations. The wild-type sequence is the 269 amino acids (amino acids 23-291) of the Swissprot accession number Swiss-Prot 059952 (derived from Thermomyces lanuginosus (Humicola lanuginosa)). Other suitable lipases include: Liprl 139, e.g. as described in WO2013/171241; TfuLip2, e.g. as described in WO2011/084412 and WO2013/033318; Pseudomonas stutzeri lipase, e.g. as described in WO2018228880; Microbulbifer thermotolerans lipase, e.g. as described in WO2018228881; Sulfobacillus acidocaldarius lipase, e.g. as described in EP3299457; LIP062 lipase e.g. as described in WO2018209026; PinLip lipase e.g. as described in WO2017036901 and Absidia sp. lipase e.g. as described in WO2017005798.

Preferred lipases would include those sold under the tradenames Lipex® and Lipolex® and Lipoclean®.

Cellulases. Suitable enzymes include cellulases of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum disclosed in U.S. Pat. Nos. 4,435,307, 5,648,263, 5,691,178, 5,776,757 and 5,691,178. Suitable cellulases include the alkaline or neutral cellulases having colour care benefits. Commercially available cellulases include CELLUZYME®, CAREZYME® and CAREZYME PREMIUM (Novozymes A/S), CLAZINASE®, and PURADAX HA® (Genencor International Inc.), and KAC-500(B)® (Kao Corporation).

The bacterial cleaning cellulase may be a glycosyl hydrolase having enzymatic activity towards amorphous cellulose substrates, wherein the glycosyl hydrolase is selected from GH families 5, 7, 12, 16, 44 or 74. Suitable glycosyl hydrolases may also be selected from the group consisting of: GH family 44 glycosyl hydrolases from Paenibacillus polyxyma (wild-type) such as XYG1006 described in U.S. Pat. No. 7,361,736 or are variants thereof. GH family 12 glycosyl hydrolases from Bacillus licheniformis (wild-type) such as SEQ ID NO:1 described in U.S. Pat. No. 6,268,197 or are variants thereof; GH family 5 glycosyl hydrolases from Bacillus agaradhaerens (wild type) or variants thereof; GH family 5 glycosyl hydrolases from Paenibacillus (wild type) such as XYG1034 and XYG 1022 described in U.S. Pat. No. 6,630,340 or variants thereof; GH family 74 glycosyl hydrolases from Jonesia sp. (wild type) such as XYG1020 described in WO 2002/077242 or variants thereof; and GH family 74 glycosyl hydrolases from Trichoderma Reesei (wild type), such as the enzyme described in more detail in Sequence ID NO. 2 of U.S. Pat. No. 7,172,891, or variants thereof. Suitable bacterial cleaning cellulases are sold under the tradenames Celluclean® and Whitezyme® (Novozymes A/S, Bagsvaerd, Denmark).

The fabric care product may comprise a fungal cleaning cellulase belonging to glycosyl hydrolase family 45 having a molecular weight of from 17 kDa to 30 kDa, for example the endoglucanases sold under the tradename Biotouch® NCD, DCC and DCL (AB Enzymes, Darmstadt, Germany).

Pectate Lyases. Other preferred enzymes include pectate lyases sold under the tradenames Pectawash®, Pectaway®, Xpect® and mannanases sold under the tradenames Mannaway® (all from Novozymes A/S, Bagsvaerd, Denmark), and Purabrite® (Genencor International Inc., Palo Alto, California).

Nucleases. The fabric care product may comprise a nuclease enzyme. The nuclease enzyme is an enzyme capable of cleaving the phosphodiester bonds between the nucleotide sub-units of nucleic acids. The nuclease enzyme herein is preferably a deoxyribonuclease or ribonuclease enzyme or a functional fragment thereof. By functional fragment or part is meant the portion of the nuclease enzyme that catalyzes the cleavage of phosphodiester linkages in the DNA backbone and so is a region of said nuclease protein that retains catalytic activity. Thus, it includes truncated, but functional versions, of the enzyme and/or variants and/or derivatives and/or homologues whose functionality is maintained. Suitable DNases include wild-types and variants described in detail by WO2017162836 and WO2018108865, and variants of the Bacillus cibi DNase including those described in WO2018011277.

RNase: suitable RNases include wild-types and variants of DNases described in WO2018178061 and WO2020074499.

Preferably the nuclease enzyme is a deoxyribonuclease, preferably selected from any of the classes E.C. 3.1.21.x, where x=1, 2, 3, 4, 5, 6, 7, 8 or 9, E.C. 3.1.22.y where y=1, 2, 4 or 5, E.C. 3.1.30.z where z=1 or 2, E.C. 3.1.31.1 and mixtures thereof.

Hexosaminidases. The fabric care product may comprise one or more hexosaminidases. The term hexosaminidase includes “dispersin” and the abbreviation “Dsp”, which means a polypeptide having hexosaminidase activity, EC 3.2.1.—that catalyzes the hydrolysis of β-1,6-glycosidic linkages of N-acetyl-glucosamine polymers found in soils of microbial origin. The term hexosaminidase includes polypeptides having N-acetylglucosaminidase activity and J-N-acetylglucosaminidase activity. Hexosaminidase activity may be determined according to Assay II described in WO2018184873. Suitable hexosaminidases include those disclosed in WO2017186936, WO2017186937, WO2017186943, WO2017207770, WO2018184873, WO2019086520, WO2019086528, WO2019086530, WO2019086532, WO2019086521, WO2019086526, WO2020002604, WO2020002608, WO2020007863, WO2020007875, WO2020008024, WO2020070063, WO2020070249, WO2020088957, WO2020088958 and WO2020207944. Variants of the Terribacillus saccharophilus hexosaminidase defined by SEQ ID NO: 1 of WO2020207944 may be preferred, especially the variants with improved thermostability disclosed in that publication.

Mannanases. The fabric care product may comprise an extracellular-polymer-degrading enzyme that includes a mannanase enzyme. The term “mannanase” means a polypeptide having mannan endo-1,4-beta-mannosidase activity (EC 3.2.1.78) from the glycoside hydrolase family 26 that catalyzes the hydrolysis of 1,4-3-D-mannosidic linkages in mannans, galactomannans and glucomannans. Alternative names of mannan endo-1,4-beta-mannosidase are 1,4-3-D-mannan mannanohydrolase; endo-1,4-3-mannanase; endo-β-1,4-mannase; β-mannanase B; 3-1,4-mannan 4-mannanohydrolase; endo-3-mannanase; and β-D-mannanase. For purposes of the present disclosure, mannanase activity may be determined using the Reducing End Assay as described in the experimental section of WO2015040159. Suitable examples from class EC 3.2.1.78 are described in WO2015040159, such as the mature polypeptide SEQ ID NO: 1 described therein.

Galactanases. The fabric care product may comprise an extracellular polymer-degrading enzyme that includes an endo-beta-1,6-galactanase enzyme. The term “endo-beta-1,6-galactanase” or “a polypeptide having endo-beta-1,6-galactanase activity” means an endo-beta-1,6-galactanase activity (EC 3.2.1.164) from the glycoside hydrolase family 30 that catalyzes the hydrolytic cleavage of 1,6-3-D-galactooligosaccharides with a degree of polymerization (DP) higher than 3, and their acidic derivatives with 4-O-methylglucosyluronate or glucosyluronate groups at the non-reducing terminals. For purposes of the present disclosure, endo-beta-1,6-galactanase activity is determined according to the procedure described in WO 2015185689 in Assay I. Suitable examples from class EC 3.2.1.164 are described in WO 2015185689, such as the mature polypeptide SEQ ID NO: 2.

The fabric care product may optionally comprise from about 0.001% to about 10%, in some examples from about 0.005% to about 8%, and in other examples, from about 0.01% to about 6%, by weight of the fabric care product, of an enzyme stabilizing system. The enzyme stabilizing system can be any stabilizing system which is compatible with the detersive enzyme. In the case of aqueous detergent compositions comprising protease, a reversible protease inhibitor, such as a boron compound, including borate, 4-formyl phenylboronic acid, phenylboronic acid and derivatives thereof, or compounds such as calcium formate, sodium formate and 1,2-propane diol may be added to further improve stability.

Without wish to be bonded by theory, the combination of enzyme and the anionic soil release polyester can effectively reduce soil redeposition across different fabric types, including polyester, cotton, polycotton, polyspandex, and others used to make consumer garments.

### Quaternary Ammonium Compound

The fabric care agent can be a quaternary ammonium compound so that the fabric care product can provide a softening or lubrication benefit to laundered fabrics.

The quaternary ammonium compound (quat) can be an ester quaternary ammonium compound. Suitable quaternary ammonium compounds include but are not limited to, materials selected from the group consisting of ester quats, amide quats, imidazoline quats, alkyl quats, amidoester quats and combinations thereof. Suitable ester quats include but are not limited to, materials selected from the group consisting of monoester quats, diester quats, triester quats and combinations thereof.

Without being bound by theory, it is thought that the cold water dissolution time of the particles that include a quaternary ammonium compound tends to decrease with increasing Iodine Value, recognizing that there is some variability with respect to this relationship.

The particles can comprise about 5% to about 45% by weight a quaternary ammonium compound. The quaternary ammonium compound can optionally have an Iodine Value from about 18 to about 60, optionally about 18 to about 56, optionally about 20 to about 60, optionally about 20 to about 56, optionally about 20 to about 42, and any whole numbers within the aforesaid ranges. Optionally the particles can comprise about 10% to about 40% by weight a quaternary ammonium compound, further optionally having any of the aforesaid ranges of Iodine Value. Optionally the particles can comprise about 20% to about 40% by weight a quaternary ammonium compound, further optionally having the aforesaid ranges of Iodine Value.

The quaternary ammonium compounds may be derived from fatty acids. The fatty acids may include saturated fatty acids and/or unsaturated fatty acids. The fatty acids may be characterized by an iodine value. The fatty acids may include an alkyl portion containing, on average by weight, from about 13 to about 22 carbon atoms, or from about 14 to about 20 carbon atoms, optionally from about 16 to about 18 carbon atoms. Suitable fatty acids may include those derived from (1) an animal fat, and/or a partially hydrogenated animal fat, such as beef tallow, lard, etc.; (2) a vegetable oil, and/or a partially hydrogenated vegetable oil such as canola oil, safflower oil, peanut oil, sunflower oil, sesame seed oil, rapeseed oil, cottonseed oil, corn oil, soybean oil, tall oil, rice bran oil, palm oil, palm kernel oil, coconut oil, other tropical palm oils, linseed oil, tung oil, etc.; (3) processed and/or bodied oils, such as linseed oil or tung oil via thermal, pressure, alkali-isomerization and catalytic treatments; (4) a mixture thereof, to yield saturated (e.g. stearic acid), unsaturated (e.g. oleic acid), polyunsaturated (linoleic acid), branched (e.g. isostearic acid) or cyclic (e.g. saturated or unsaturated α-disubstituted cyclopentyl or cyclohexyl derivatives of polyunsaturated acids) fatty acids.

The quaternary ammonium compound may comprise compounds formed from fatty acids that are unsaturated. The fatty acids may comprise unsaturated C18 chains, which may be include a single double bond (“C18:1”) or may be double unsaturated (“C18:2”).

The quaternary ammonium compound may be derived from fatty acids and optionally from triethanolamine, optionally unsaturated fatty acids that include eighteen carbons (“C18 fatty acids”), optionally C18 fatty acids that include a single double bone (“C18:1 fatty acids”).

The quaternary ammonium compound may comprise from about 10% to about 95%, or from about 10% to about 90%, or from about 15% to about 80%, by weight of the quaternary ammonium compound, of compounds derived from triethanolamine and C18:1 fatty acids.

Suitable quaternary ammonium ester compounds may be derived from alkanolamines, for example, C1-C4 alkanolamines, optionally C2 alkanolamines (e.g., ethanolamines). The quaternary ammonium ester compounds may be derived from monoalkanolamines, dialkanolamines, trialkanolamines, or mixtures thereof, optionally monoethanolamines, diethanolamines, di-isopropanolamines, triethanolamines, or mixtures thereof. The alkanolamines from which the quaternary ammonium ester compounds are derived may be alkylated mono- or dialkanolamines, for example C1-C4 alkylated alkanolamines, optionally C1 alkylated alkanolamines (e.g, N-methyldiethanolamine).

The quaternary ammonium ester compound may comprise a quaternized nitrogen atom that is substituted, at least in part. The quaternized nitrogen atom may be substituted, at least in part, with one or more C1-C3 alkyl or C1-C3 hydroxyl alkyl groups. The quaternized nitrogen atom may be substituted, at least in part, with a moiety selected from the group consisting of methyl, ethyl, propyl, hydroxyethyl, 2-hydroxypropyl, 1-methyl-2-hydroxyethyl, poly(C₂-C₃ alkoxy), polyethoxy, benzyl, optionally methyl or hydroxyethyl.

The quaternary ammonium ester compound may comprise compounds according to Formula (I):

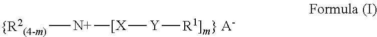

wherein:
m is 1, 2 or 3, with provisos that, in a given molecule, the value of each m is identical, and when (a) the quaternary ammonium ester compound comprises triester quaternary ammonium material (“triester quat”), for at least some of the compounds according to Formula (I), m is 3 (i.e., a triester);
each R¹, which may comprise from 13 to 22 carbon atoms, is independently a linear hydrocarbyl or branched hydrocarbyl group, optionally R¹ is linear, optionally R¹ is partially unsaturated linear alkyl chain;
each R² is independently a C₁-C₃ alkyl or hydroxyalkyl group and/or each R² is selected from methyl, ethyl, propyl, hydroxyethyl, 2-hydroxypropyl, 1-methyl-2-hydroxyethyl, poly(C₂-C₃ alkoxy), polyethoxy, benzyl, optionally methyl or hydroxyethyl;
each X is independently —(CH₂)n-, —CH₂—CH(CH₃)— or —CH(CH₃)—CH₂—, where
each n is independently 1, 2, 3 or 4, optionally each n is 2;
each Y is independently —O—(O)C— or —C(O)—O—; and
A- is independently selected from the group consisting of chloride, bromide, methyl sulfate, ethyl sulfate, sulfate, and nitrate, optionally A- is selected from the group consisting of chloride and methyl sulfate, optionally A- is methyl sulfate.

At least one X, optionally each X, may be independently selected from —CH₂—CH(CH₃)— or —CH(CH₃)—CH₂—. When m is 2, X may be selected from *—CH₂—CH(CH₃)—, *—CH(CH₃)—CH₂—, or a mixture thereof, where the * indicates the end nearest the nitrogen of the quaternary ammonium ester compound. When there are two or more X groups present in a single compound, at least two of the X groups may be different from each other. For example, when m is 2, one X (e.g., a first X) may be *—CH₂—CH(CH₃)—, and the other X (e.g., a second X) may be *—CH(CH₃)—CH₂—, where the * indicates the end nearest the nitrogen of the quaternary ammonium ester compound. It has been found that such selections of the m index and X groups can improve the hydrolytic stability of the quaternary ammonium ester compound, and hence further improve the stability of the fabric care product.

For similar stability reasons, the quaternary ammonium ester compound may comprise a mixture of: bis-(2-hydroxypropyl)-dimethylammonium methylsulfate fatty acid ester; (2-hydroxypropyl)-(1-methyl-2-hydroxyethyl)-dimethylammonium methylsulfate fatty acid ester; and bis-(1-methyl-2-hydroxyethyl)-dimethylammonium methylsulfate fatty acid ester; where the fatty acid esters are produced from a C12-C18 fatty acid mixture. The quaternary ammonium ester compound may comprise any of the fatty acid esters, individually or as a mixture, listed in this paragraph.

Each X may be —(CH₂)n-, where each n is independently 1, 2, 3 or 4, optionally each n is 2.

Each R¹ group may correspond to, and/or be derived from, the alkyl portion(s) of any of the fatty acids provided above. The R¹ groups may comprise, by weight average, from about 13 to about 22 carbon atoms, or from about 14 to about 20 carbon atoms, optionally from about 16 to about 18 carbon atoms. It may be that when Y is *—O—(O)C— (where the * indicates the end nearest the X moiety), the sum of carbons in each R¹ is from 13 to 21, optionally from 13 to 19.

The quaternary ammonium compounds of the present disclosure may include a mixture of quaternary ammonium compounds according to Formula (I), for example, having some compounds where m=1 (e.g., monoesters) and some compounds where m=2 (e.g., diesters). Some mixtures may even contain compounds where m=3 (e.g., triesters). The quaternary ammonium compounds may include compounds according to Formula (I), where m is 1 or 2, but not 3 (e.g., is substantially free of triesters).

The quaternary ammonium compounds of the present disclosure may include compounds according to Formula (I), wherein each R² is a methyl group. The quaternary ammonium compounds of the present disclosure may include compounds according to Formula (I), wherein at least one R², optionally wherein at least one R² is a hydroxyethyl group and at least one R² is a methyl group. For compounds according to Formula (I), m may equal 1, and only one R² may be a hydroxyethyl group.

The quaternary ammonium compounds of the present disclosure may include methyl sulfate as a counterion. When the quaternary ammonium ester compounds of the present disclosure comprise compounds according to Formula (I), A- may optionally be methyl sulfate.

The quaternary ammonium compounds of the present disclosure may comprise one or members selected from the group consisting of:
(A) bis-(2-hydroxypropyl)-dimethylammonium methylsulfate fatty acid ester and isomers of bis-(2-hydroxypropyl)-dimethylammonium methylsulfate fatty acid ester and/or mixtures thereof; N,N-bis-(2-(acyl-oxy)-propyl)-N,N-dimethylammonium methylsulfate and/or N-(2-(acyl-oxy)-propyl)N-(2-(acyl-oxy) 1-methyl-ethyl) N,N-dimethylammonium methylsulfate and/or mixtures thereof, in which the acyl moiety is derived from c12-c22 fatty acids such as Palm, Tallow, Canola and/or other suitable fatty acids, which can be fractionated and/or hydrogenated, and/or mixtures thereof;
(B) 1,2-di(acyloxy)-3-trimethylammoniopropane chloride in which the acyl moiety is derived from c12-c22 fatty acids such as Palm, Tallow, Canola and/or other suitable fatty acids, which can be fractionated and/or hydrogenated, and/or mixtures thereof;
(C) N,N-bis(hydroxyethyl)-N,N-dimethyl ammonium chloride fatty acid esters; N,N-bis(acyl-oxy-ethyl)-N,N-dimethyl ammonium chloride in which the acyl moiety is derived from C12-C22 fatty acids such as Palm, Tallow, Canola and/or other suitable fatty acids, which can be fractionated and/or hydrogenated, and/or mixtures thereof, such as N,N-bis(tallowoyl-oxy-ethyl) N,N-dimethyl ammonium chloride;
(D) esterification products of Fatty Acids with Triethanolamine, quaternized with Dimethyl Sulphate; N,N-bis(acyl-oxy-ethyl)N-(2-hydroxyethyl)-N-methyl ammonium methylsulfate in which the acyl moiety is derived from C12-C22 fatty acids such as Palm, Tallow, Canola and/or other suitable fatty acids, which can be fractionated and/or hydrogenated, and/or mixtures thereof, such as N,N-bis(tallowoyl-oxy-ethyl)N-(2-hydroxyethyl)-N-methyl ammonium methylsulfate;
(E) dicanoladimethylammonium chloride; di(hard)tallowdimethylammonium chloride; dicanoladimethylammonium methylsulfate; 1-methyl-1-stearoylamidoethyl-2-stearoylimidazolinium methylsulfate; 1-tallowylamidoethyl-2-tallowylimidazoline; dipalmylmethyl hydroxyethylammoinum methylsulfate; and/or
(F) mixtures thereof.

Examples of suitable quaternary ammonium ester compound are commercially available from Evonik under the tradename REWOQUAT WE18 and/or REWOQUAT WE20, and from Stepan under the tradename STEPANTEX GA90, STEPANTEX VK90, and/or STEPANTEX VL90A.

It is understood that compositions that comprise a quaternary ammonium ester compound as a fabric conditioning active may further comprise non-quaternized derivatives of such compounds, as well as unreacted reactants (e.g., free fatty acids).

The quaternary ammonium compound can be that used as part of BOUNCE dryer sheets available from The Procter & Gamble Company, Cincinnati, Ohio, USA. The quaternary ammonium compound can be the reaction product of triethanolamine and partially hydrogenated tallow fatty acids quaternized with dimethyl sulfate.

It will be understood that combinations of quaternary ammonium compounds disclosed above are suitable for use in this invention.

The particles, or adjunct particles if used, can comprise from about 10 to about 40% by weight quaternary compound.

The iodine value of a quaternary ammonium compound is the iodine value of the parent fatty acid from which the compound is formed and is defined as the number of grams of iodine which react with 100 grams of parent fatty acid from which the compound is formed.

First, the quaternary ammonium compound is hydrolysed according to the following protocol: 25 g of quaternary ammonium compound is mixed with 50 mL of water and 0.3 mL of sodium hydroxide (50% activity). This mixture is boiled for at least an hour on a hotplate while avoiding that the mixture dries out. After an hour, the mixture is allowed to cool down and the pH is adjusted to neutral (pH between 6 and 8) with sulfuric acid 25% using pH strips or a calibrated pH electrode.

Next the fatty acid is extracted from the mixture via acidified liquid-liquid extraction with hexane or petroleum ether: the sample mixture is diluted with water/ethanol (1:1) to 160 mL in an extraction cylinder, 5 grams of sodium chloride, 0.3 mL of sulfuric acid (25% activity) and 50 mL of hexane are added. The cylinder is stoppered and shaken for at least 1 minute. Next, the cylinder is left to rest until 2 layers are formed. The top layer containing the fatty acid in hexane is transferred to another recipient. The hexane is then evaporated using a hotplate leaving behind the extracted fatty acid.

Next, the iodine value of the parent fatty acid from which the fabric conditioning active is formed is determined following ISO3961:2013. The method for calculating the iodine value of a parent fatty acid comprises dissolving a prescribed amount (from 0.1-3 g) into 15 mL of chloroform. The dissolved parent fatty acid is then reacted with 25 mL of iodine monochloride in acetic acid solution (0.1M). To this, 20 mL of 10% potassium iodide solution and 150 mL deionised water is added. After the addition of the halogen has taken place, the excess of iodine monochloride is determined by titration with sodium thiosulphate solution (0.1M) in the presence of a blue starch indicator powder. At the same time a blank is determined with the same quantity of reagents and under the same conditions. The difference between the volume of sodium thiosulphate used in the blank and that used in the reaction with the parent fatty acid enables the iodine value to be calculated.

### Silicone

The fabric care active agent can be a silicone. The fabric care product can comprise from about 0.1% to about 60% of silicone by weight of the fabric care product. Alternatively, the fabric care product can comprise about 3% to about 50%, preferably from about 10% to about 40%, more preferably from about 20% to about 35%, e.g., from about 28% to about 32%, of silicone by weight of the fabric care product.

### Cationic Polymer

The fabric care active agent can be a cationic polymer. Cationic polymers can provide the benefit of a deposition aid that helps to deposit, onto the fabric, quaternary ammonium compound and possibly some other benefit agents that are contained in the particles. Optionally, the cationic polymer can be provided as or in an adjunct particle.

The fabric care product can comprise from about 0.5% to about 10% by weight cationic polymer. Optionally, the fabric care product can comprise from about 0.5% to about 5% by weight cationic polymer, or even about 1% to about 5% by weight, or even about 2% to about 4% by weight cationic polymer, or even about 3% by weight cationic polymer.

Non-limiting examples of cationic polymers are cationic or amphoteric, polysaccharides, proteins and synthetic polymers. Cationic polysaccharides include cationic cellulose derivatives, cationic guar gum derivatives, chitosan and its derivatives and cationic starches. Suitable cationic polysaccharides include cationic cellulose ethers, particularly cationic hydroxyethylcellulose and cationic hydroxypropylcellulose.

Cationic polymers including those with the INCI name Polyquaternium-4; Polyquaternium-6; Polyquaternium-7; Polyquaternium-10; Polyquaternium-22; Polyquaternium-67; and mixtures thereof can be suitable. Other suitable polysaccharides include hydroxyethyl cellulose or hydoxypropylcellulose quaternized with glycidyl C₁₂-C₂₂ alkyl dimethyl ammonium chloride. The cationic polymer can be cationic guar gum or cationic locust bean gum. An example of a cationic guar gum is a quaternary ammonium derivative of hydroxypropyl guar. In another aspect, the cationic polymer may be selected from the group consisting of cationic polysaccharides. In one aspect, the cationic polymer may be selected from the group consisting of cationic cellulose ethers, cationic galactomanan, cationic guar gum, cationic starch, and combinations thereof. The cationic polymer can be provided in a powder form. The cationic polymer can be provided in an anhydrous state.

### Fatty Acid

The fabric care active agent can be fatty acid. The term “fatty acid” is used herein in the broadest sense to include unprotonated or protonated forms of a fatty acid. One skilled in the art will readily appreciate that the pH of an aqueous composition will dictate, in part, whether a fatty acid is protonated or unprotonated. The fatty acid may be in its unprotonated, or salt form, together with a counter ion, such as, but not limited to, calcium, magnesium, sodium, potassium, and the like. The term “free fatty acid” means a fatty acid that is not bound to another chemical moiety (covalently or otherwise).

The fatty acid may include those containing from 12 to 25, from 13 to 22, or even from 16 to 20, total carbon atoms, with the fatty moiety containing from 10 to 22, from 12 to 18, or even from 14 (mid-cut) to 18 carbon atoms.

Mixtures of fatty acids from different fat sources can be used. Branched fatty acids such as isostearic acid are also suitable since they may be more stable with respect to oxidation and the resulting degradation of color and odor quality. The fatty acid may have an iodine value from 0 to 140, from 10 to 120, from 50 to 120 or even from 85 to 105.

The fabric care product can comprise from about 0% to about 40%, optionally from about 1% to about 40%, by weight fatty acid. The fatty acid can be selected from the group consisting of, a saturated fatty acids, unsaturated fatty acid, and mixtures thereof. The fatty acid can be a blend of saturated fatty acids, a blend of unsaturated fatty acids, and mixtures thereof. The fatty acid can be substituted or unsubstituted. The fatty acid can be provided with the quaternary ammonium compound. The fatty acid can have an Iodine Value of zero.

The fatty acid can be selected from the group consisting of stearic acid, palmitic acid, coconut oil, palm kernel oil, stearic acid palmitic acid blend, oleic acid, vegetable oil, partially hydrogenated vegetable oil, and mixtures thereof.

The fatty acid can be Stearic acid CAS No. 57-11-4. The fatty acid can be palmitic acid CAS No. 57-10-3. The fatty acid can be a blend of stearic acid and coconut oil. The fatty acid can be C12 to C22 fatty acid. C12 to C22 fatty acid can have tallow or vegetable origin, can be saturated or unsaturated, can be substituted or unsubstituted.

### Carbon Source of Raw Materials:

The raw materials for preparation of the surfactant, polymers and other ingredients can be based on fossil carbon or renewable carbon. Renewable carbon is a carbon source that avoid the use of fossil carbon such as natural gas, coal, petroleum. Typically, renewable carbon is derived from the biomass, carbon capture, or chemical recycling.

Biomass is a renewable carbon source formed through photosynthesis in the presence of sunlight, or chemosynthesis process in the absence of sunlight. In some cases, polymers isolated from biomass can be used directly, or further derivatized to make performance polymers. For example, the use of polysaccharide (such as starch) and derivatized polysaccharide (such as cellulose derivatives, guar derivatives, dextran derivatives) in fabric home care composition are known. In some cases, biomass can be converted into basic chemicals under certain thermal, chemical, or biological conditions. For example, bioethanol can be derived from biomass such as straw, and further convert to biobased polyethylene glycol. Other nonlimiting examples of renewable carbon from biomass include plants (e.g., sugar cane, beets, corn, potatoes, citrus fruit, woody plants, lignocellulosics, hemicellulosics, cellulosic waste), animals, animal fats, fish, bacteria, fungi, plant-based oils, and forestry products. These resources can be naturally occurring, hybrids, or genetically engineered organisms.

Carbon capture is another renewable carbon source which use various process to capture CO₂ or methane from industrial or natural processes, or directly from air (direct capture). Captured methane and CO₂ maybe converted into syngas, and/or further convert to basic chemicals, including but not limit to methanol, ethanol, fatty alcohols such as C₁₂/C₁₄ or even C₁₆/C₁₈ alcohols, other alcohols, olefins, alkanes, saturated and unsaturated organic acids, etc. These basic chemicals can used as or further convert to monomers for making transformed to usable chemicals by e.g. catalytic processes, such as the Fischer-Tropsch process or by fermentation by C₁-fixing microorganisms.

Chemical recycling is another renewable carbon source which allow plastics from waste management industry to be recycled and converted into base chemicals and chemical feedstocks. In some cases, waste plastics which cannot be re-used or mechanical recycled are convert to hydrocarbons or basic petrochemicals through gasification, pyrolysis or hydrothermal treatment processes, the hydrocarbons and basic petrochemicals can be further convert into monomers for polymers. In some cases, waste plastics are depolymerized into monomers to make new polymers. It is also possible that waste plastics are depolymerized into oligomers, the oligomers can be used as building blocks to make new polymers. The waste plastic converted by various processes to a waste plastic feedstock for the above materials may either be used alone or in combination with traditional surfactant feedstocks, such as kerosene, polyolefins derived from natural gas, coal, crude oil or even biomass, or waste fat/oil-derived paraffin and olefin, to produce biodegradable surfactants for use in detergents and other industries (thereby providing a benefit to society).

Preferably, the surfactant, polymers and other ingredients contains renewable carbon, the Renewable Carbon Index (RCI, a measure of sustainability by dividing the number of carbons derived from renewable sources by the total number of carbons in an active ingredient) of the polymer is above 10%, more preferably above 30%, more preferably above 50%, more preferably above 60%, more preferably between 70% to 100% (including 100%), and most preferably 100%.

### Method of Usage

The fabric care product comprising the particles disclosed herein can be conveniently employed to treat laundry articles. The steps of the process can be to provide such particles comprising the formulation components disclosed herein. A dose of the particles can be placed in a dosing cup. The dosing cup can be the closure of a package containing the particles. The dosing cup can be a detachable and attachable dosing cup that is detachable and attachable to a package containing the particles or to the closure of such package. The dose of the particles in the dosing cup can be dispensed into a washing machine. The step of dispensing the particles in the washing machine can take place by pouring the particles into the washing machine or placing the dosing cup and the particles contained therein into the washing machine.

The process for treating laundry can comprise the steps of providing laundry in a washing machine. The fabric care product can be dispensed into the washing machine. The laundry can be contacted with water. The fabric care product can be dissolved in the water to form a laundry treatment liquor. The laundry can be contacted with the laundry treatment liquor. The laundry can be contacted with water during the wash sub-cycle of the washing machine.

The process can optionally comprise a step of contacting the laundry during the wash sub-cycle with a detergent composition comprising an anionic surfactant. During the wash sub-cycle, the wash basin may be filled or at least partially filled with water. The particles can dissolve into the water to form a wash liquor comprising the components of the particles. Optionally, if a detergent composition is employed, the wash liquor can include the components of the detergent composition and the particles or dissolved particles. The particles can be placed in the wash basin of the washing machine before the laundry is placed in the wash basin of the washing machine. The particles can be placed in the wash basin of the washing machine after the laundry is placed in the wash basin of the washing machine. The particles can be placed in the wash basin prior to filling or partially filling the wash basin with water or after filling of the wash basin with water has commenced. If a detergent composition is employed by the consumer in practicing the process of treating laundry, the detergent composition and particles can be provided from separate packages. For instance, the detergent composition can be a liquid detergent composition provided from a bottle, sachet, water-soluble, dosing cup, dosing ball, or cartridge associated with the washing machine. The particles can be provided from a separate package, by way of non-limiting example, a carton, bottle, water-soluble, dosing cup, sachet, or the like. If the detergent composition is a solid form, such as a powder, water-soluble fibrous substrate, water-soluble sheet, water-soluble film, water-soluble film, water insoluble fibrous web carrying solid detergent composition, the particles can be provided with the solid form detergent composition. For instance, the particles can be provided from a container containing a mixture of the solid detergent composition and the particles. Optionally, the particles can be provided from a pouch formed of a detergent composition that is a water-soluble fibrous substrate, water-soluble sheet, water-soluble film, water-soluble film, water insoluble fibrous web carrying solid detergent composition.

### Production of Particles

For a water-soluble carrier that can be processed conveniently as a melt, the rotoforming process can be used to produce the particles. A mixture of molten water-soluble carrier and the other materials constituting the particles is prepared, for instance in a batch or continuous mixing process. The molten mixture can be pumped to a rotoformer, for instance a Sandvik ROTOFORM 3000 having a 750 mm wide 10 m long belt. The rotoforming apparatus can have a rotating cylinder. The cylinder can have 2 mm diameter apertures set at a 10 mm pitch in the cross machine-direction and 9.35 mm pitch in the machine direction. The cylinder can be set at approximately 3 mm above the belt. The belt speed and rotational speed of the cylinder can be set at about 10 m/min. The molten mixture can be passed through the apertures in the rotating cylinder and deposited on a moving conveyor that is provided beneath the rotating cylinder.

The molten mixture can be cooled on the moving conveyor to form a plurality of solid particles. The cooling can be provided by ambient cooling. Optionally the cooling can be provided by spraying the under-side of the conveyor with ambient temperature water or chilled water.

Once the particles are sufficiently coherent, the particles can be transferred from the conveyor to processing equipment downstream of the conveyor for further processing and or packaging.

Optionally, the particles can be provided with inclusions of a gas. Such occlusions of gas, for example air, can help the particles dissolve more quickly in the wash. Occlusions of gas can be provided, by way of nonlimiting example, by injecting gas into the molten precursor material and milling the mixture.

Particles can also be made using other approaches. For instance, granulation or press agglomeration can be appropriate. In granulation, the precursor material containing the constituent materials of the particles is compacted and homogenized by rotating mixing tools and granulated to form particles. For precursor materials that are substantially free of water, a wide variety of sizes of particles can be made.

In press agglomeration, the precursor material containing the constituent materials of the particles is compacted and plasticized under pressure and under the effect of shear forces, homogenized and then discharged from the press agglomeration machine via a forming/shaping process. Press agglomeration techniques include extrusion, roller compacting, pelleting, and tableting.

The precursor material containing the constituent materials of the particles can be delivered to a planetary roll extruder or twin-screw extruder having co-rotating or contra-rotating screws. The barrel and the extrusion granulation head can be heated to the desired extrusion temperature. The precursor material containing the constituent materials of the particles can be compacted under pressure, plasticized, extruded in the form of strands through a multiple-bore extrusion die in the extruder head, and sized using a cutting blade. The bore diameter of the extrusion header can be selected to provide for appropriately sized particles. The extruded particles can be shaped using a spheronizer to provide for particles that have a spherical shape.

Optionally, the extrusion and compression steps may be carried out in a low-pressure extruder, such as a flat die pelleting press, for example as available from Amandus Kahl, Reinbek, Germany. Optionally, the extrusion and compression steps may be carried out in a low-pressure extruder, such as a BEXTRUDER, available from Hosokawa Alpine Aktiengesellschaft, Augsburg, Germany.

The particles can be made using roller compacting. In roller compacting the precursor material containing the constituent materials of the particles is introduced between two rollers and rolled under pressure between the two rollers to form a sheet of compactate. The rollers provide a high linear pressure on the precursor material. The rollers can be heated or cooled as desired, depending on the processing characteristics of the precursor material. The sheet of compactate is broken up into small pieces by cutting. The small pieces can be further shaped, for example by using a spheronizer.

### Examples

The examples below are intended to illustrate the invention in detail without, however, limiting it thereto. Unless explicitly stated otherwise, all percentages given are percentages by weight (% by wt. or wt.-%, or wt. %).

### Anionic Soil Release Polyester Preparation.

General procedure for the preparation of the anionic soil release polyesters.

The polymer synthesis is carried out by the reaction of dimethyl terephthalate (DMT), dimethyl-5-sulfoisophthalate sodium salt (5-SIM), 1,2-propylene glycol and/or ethylene glycol, alkyl capped polyalkylene glycol (mono hydroxyl-functional polyalkylene glycol monoalkyl ether), and optionally polyalkylene glycol, using sodium acetate (NaOAc) and tetraisopropyl orthotitanate (IPT) as the catalyst system. The synthesis is a two-step procedure. The first step is a trans-esterification and the second step is a polycondensation.

Key to reactants or ingredients used in the examples:
5-SIM is dimethyl-5-sulfoisophthalate sodium salt
DMT is dimethyl terephthalate
EG is ethylene glycol
IPT is tetraisopropyl orthotitanate
mPEG2000 is mono hydroxyl-functional polyethylene glycol monomethyl ether, average molecular weight 2000 g/mol
mPEG3000 is mono hydroxyl-functional polyethylene glycol monomethyl ether, average molecular weight 3000 g/mol
mPEG4000 is mono hydroxyl-functional polyethylene glycol monomethyl ether, average molecular weight 4000 g/mol
NaOAc is sodium acetate
PEG300 is di-hydroxyl-functional poly(ethylene glycol), average molecular weight 300 g/mol
PG is 1,2-propylene glycol

### Anionic Soil Release Polyester 1

83.22 g (0.42 mol) of dimethyl terephthalate (DMT), 42.3 g (0.14 mol) of dimethyl-5-sulfoisophthalate sodium salt (5-SIM), 40.05 g (0.53 mol) of 1,2-propylene glycol (PG), 34.60 g (0.56 mol) of ethylene glycol (EG), 200 g (0.10 mol) of mPEG2000 and 0.5 g of sodium acetate (NaOAc) (anhydrous) are weighed into a reaction vessel at room temperature. For the melting process and homogenization, the mixture is heated up to 110-120° C. 200 μL of tetraisopropyl orthotitanate (IPT) is added and the mixture is further heated up to 210° C. over 3 hours sparged by a nitrogen stream. During the transesterification methanol is released from the reaction and is distilled out of the system. Once the head-temperature is below 55° C., nitrogen is switched off and the pressure is reduced to 10 mbar. PG and EG are distilled out of the system. The mixture is stirred for further 4 hours at a pressure of 10 mbar. The reaction mixture is cooled down to 140-150° C. Vacuum is released with nitrogen and the polyester is transferred out of the reactor. The weight percentage of PEG moiety, derived from polyalkylene glycol monoalkyl ether is 62 wt. %.

Anionic soil release polyester examples 2 to 4 are synthesized according to similar procedure as polyester example 1 with monomer type and dosage described in Table 1.

### Anionic Soil Release Polyester 5

58.26 g (0.30 mol) of DMT, 29.63 g (0.10 mol) of 5-SIM, 28.04 g (0.37 mol) of PG, 24.19 g (0.39 mol) of EG, 10.50 g (0.04 mol) of PEG300, 140 g (0.07 mol) of mPEG2000 and 0.38 g of NaOAc (anhydrous) are weighed into a reaction vessel at room temperature. For the melting process and homogenization, the mixture is heated up to 110-120° C. 134 μL of IPT is added and the mixture is further heated up to 210° C. over 3 hours sparged by a nitrogen stream. During the transesterification methanol is released from the reaction and is distilled out of the system. Once the head-temperature is below 55° C., nitrogen is switched off and the pressure is reduced to 10 mbar. PG and EG are distilled out of the system. The mixture is stirred for further 4 hours at a pressure of 10 mbar. The reaction mixture is cooled down to 140-150° C. Vacuum is released with nitrogen and the polyester is transferred out of the reactor. The average number of moles of polyalkylene glycol PEG300 per mole of polyester is 1.0. The weight percentage of PEG moiety, derived from polyalkylene glycol monoalkyl ether and polyalkylene glycol is 64 wt. %.

### Comparative Polyester Example 1

116.50 g (0.59 mol) of DMT, 59.25 g (0.20 mol) of 5-SIM, 56.07 g (0.74 mol) of PG, 48.40 g (0.78 mol) of EG, 29.10 g (0.14 mol) of methoxytetraethylene glycol (MetEG) and 0.5 g of NaOAc (anhydrous) are weighed into a reaction vessel at room temperature. For the melting process and homogenization, the mixture is heated up to 110-120° C. 200 μL of IPT is added and the mixture is further heated up to 210° C. over 3 hours sparged by a nitrogen stream. During the transesterification methanol is released from the reaction and is distilled out of the system. Once the head-temperature is below 55° C., nitrogen is switched off and the pressure is reduced to 10 mbar. PG and EG are distilled out of the system. The mixture is stirred for further 4 hours at a pressure of 10 mbar. The reaction mixture is cooled down to 140-150° C. Vacuum is released with nitrogen and the polyester is transferred out of the reactor.

TABLE 1
Monomer type and dosage for the preparation of anionic
soil release polyester 1-5 and Comparative polyester 1.

| | | | | | | Comparative |
|---|---|---|---|---|---|---|
| | Inventive polymer: Anionic soil release polyester | | | | | polyester |
| Monomer | 1 | 2 | 3 | 4 | 5 | 1 |
| DMT (g) | 83.22 | 58.26 | 29.13 | 27.55 | 58.26 | 116.50 |
| 5-SIM | 42.3 | 29.63 | 14.81 | 14.01 | 29.63 | 59.25 |
| (g) | | | | | | |
| PG (g) | 40.05 | 28.04 | 14.02 | 0.00 | 28.04 | 56.07 |
| EG (g) | 34.60 | 24.19 | 12.10 | 22.25 | 24.19 | 48.40 |
| PEG300 | — | — | — | — | 10.50 | — |
| (g) | | | | | | |
| Type of | mPEG2000 | mPEG3000 | mPEG4000 | mPEG2000 | mPEG2000 | MetEG |
| terminal | | | | | | |
| unit | | | | | | |
| (end-cap) | | | | | | |
| terminal | 200 | 210 | 140 | 66.19 | 140 | 29.10 |
| unit (g) | | | | | | |
| NaOAc | 0.50 | 0.38 | 0.19 | 0.10 | 0.38 | 0.5 |
| (g) | | | | | | |
| IPT (μL) | 200 | 134 | 80 | 40 | 134 | 200 |
| PEG | 62 | 71 | 76 | 62 | 64 | 14 |
| Wt. % ^{a} | | | | | | |

^{a} weight percentage of PEG moiety, derived from polyalkylene glycol monoalkyl ether and/or polyalkylene glycol.

The weight percentage of PEG moiety in an anionic soil release polyester is calculated as 1) an anionic soil release polyester has end-caps on both sides, 2) used DMT and 5-SIM are equally integrated into a anionic soil release polyester and 3) the excess amount of PG and EG are equally distilled out of the system.

### Polymer Biodegradability.

The biodegradability of anionic soil release polyesters is determined following the OECD 301B Ready Biodegradability CO₂ Evolution Test Guideline. In this study, the test substance is the sole carbon and energy source and under aerobic conditions microorganisms metabolize the test substance producing CO₂ or incorporating the carbon into biomass. The amount of CO₂ produced by the test substance (corrected for the CO₂ evolved by the blank inoculum) is expressed as a percentage of the theoretical amount of CO₂ (ThCO₂) that could have been produced if the organic carbon in the test substance was completely converted to CO₂.

The anionic soil release polyesters in present invention typically show a biodegradability of more than 40%, or more than 50%, or even more than 60% biodegradability within 28 days in OECD 301B test.

Dispersion of Soil Release Polyester into Melted PEG8000.

A plastic cup is added pre-weighted PEG 8000, and the sealed cup is placed in an oven at 70° C. until the PEG 8000 melts. To this melt is added the desired amount of soil release polyester with ambient temperature. The composition is mixed with agitation blade under 70°

TABLE 2
Dispersion of inventive polymer vs. comparative polymer

| | Soil release polyester | Dispersion in PEG |
|---|---|---|
| Inventive | Inventive polymer 2 | <120 s |
| | | (homogeneous mixture) |
| Inventive | Inventive polymer 3 | <120 s |
| | | (homogeneous mixture) |
| Comparative | Comparative polyester | >600 s (undispersed |
| | 1 | particle visually available) |

### Making of Inventive and Comparative Particles.

To prepare small scale batches of particles, a benchtop procedure was used. A plastic cup is added pre-weighted PEG 8000, and the sealed cup is placed in an oven at 70° C. until the PEG 8000 melts. To this melt is added the desired amount of soil release polyester with ambient temperature. The composition is mixed with agitation blade for 10 min under 70° C. The mixed melt is immediately poured onto a silicone mold with 5 mm in diameter, hemispherical indentations and the material is evenly spread with a large metal mixing spatula. The composition mixture is cooled to room temperature for at least 5 minutes to solidify. Once cooled, the particles are removed from the mold and collected for further testing. A list of inventive and comparative particles is made in Table 3.

### Dissolution of Inventive and Comparative Particles.

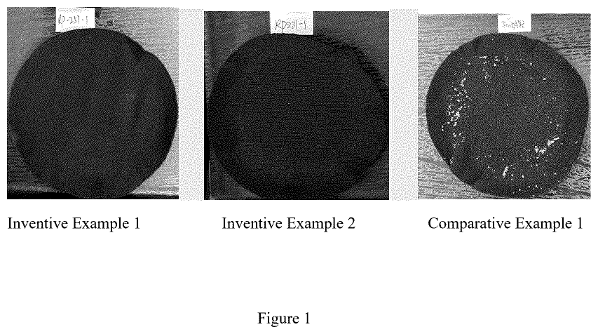

Dissolution was tested by dissolving 0.6 g beads into 500 mL city water (hardness=16 gpg), blended with magnetic stirrer for 10 min. Then the solution was vacuum filtrated by using a piece of black fabric as filter. After filtration, the image of the black fabric (wet) is captured using camera. The results of the images are shown in FIG. 1, and it shows that the Inventive Examples 1 and 2 are fully dissolved with no residue on black fabric, while the comparative Example 1 has undesirable dissolution, i.e., has residue on the black fabric.

TABLE 3
Inventive Examples 1-2 and Comparative Example

| | Inventive | Inventive | Comparative |
|---|---|---|---|
| Composition Ingredient | Example 1 | Example 2 | Example |
| Inventive polymer 2 | 5.0% | 0 | 0 |
| Inventive polymer 3 | 0 | 5.0% | 0 |
| Comparative polymer 1 | 0 | 0 | 5.0% |
| PEG8000 | balance | balance | balance |
| Total | 100% | 100% | 100% |

Cleaning Performance in Combination with Detergent.

Inventive composition (such as Inventive Example 1 and 2 in Table 3) has advantage on cleaning versus comparative composition (such as Comparative Example in Table 3) when combined with a detergent. The benefit can be demonstrated using liquid detergent base below in Table 4 and the cleaning method below.

Liquid detergent composition E is prepared as a base detergent by traditional means known to those of ordinary skill in the art by mixing the listed ingredients (Table 4).

TABLE 4
Base detergent.

| Ingredients (wt. %) | E |
|---|---|
| AES | 23.95 |
| Nonionic Surfactant | 9.24 |
| LAS | 4.79 |
| Hydrogenated Castor Oil | 2.5 |
| Amine Oxide | 1.596 |
| Enzyme (including Protease, Amylase, Mannanase, Pectawash) | 1.46 |
| Citric Acid | 1.11 |
| Monoethanolamine | 1.08 |
| Preservative | 1.0673 |
| Ethanol | 0.8 |
| Perfume | 0.739 |
| Chelant | 0.52 |
| Caustic (NaOH) | 0.46 |
| Sodium Cumene Sulfonate | 0.22 |
| Suds Suppressor | 0.116 |
| Ethanolamine | 0.055 |
| Dye | 0.0035 |
| Water/Minors | Balance |

Chelant = DETA + GLDA
Perfume = Free perfume + PMC (Perfume Micro Capsule)

Cleaning benefit is evaluated using automatic tergotometer. Test stains used for the cleaning test is burnt butter on polycotton (burnt butter ex Equest, polycotton is 50/50 polyester/cotton). Other stains can also be used, such as: Dust Sebum on polycotton ex CFT, Highly Discriminating Sebum on polycotton ex CFT.

The stains are analyzed using Image Analysis System for Laundry stain removal testing before and after the wash.

SBL2004 test soil strips supplied by WFK Testgewebe GmbH are used to simulate consumer soil levels (mix of body soil, food, dirt etc.). Every 1 SBL2004 strip is loaded with 8 g soil. The SBL2004 test soil strips were cut into 6×6 cm squares for use in the test.

Additional ballast (background fabric swatches) is also used to simulate a fabric load and provide mechanical energy during the real laundry process. Ballast loads are comprised of knitted cotton swatches at 6×6 cm size.

The desired amount of base detergent, polyester stock solution, and composition of this invention are dosed into 1 μL water (at defined hardness) in each tergotometer pot. 60 total grams of fabrics including stains (2 internal replicates of each stain in each pot), defined amount of 6×6 cm SBL2004 and ballast are washed and rinsed in the tergotometer pot under defined conditions. The test is repeated 4 times (4 external replicates).

Fabrics are then dried overnight under humidity and temperature control (50% RH, 20±2° C.), then stains are measured again using Image Analysis System for Laundry stain removal testing.

Stain Removal Index (SRI) are automatically calculated from the L, a, b values using the formula shown below Table 5. The higher the SRI, the better the stain removal.

$$SRI = 100 * ( ( Δ {E}_{b} - Δ {E}_{a} ) / Δ {E}_{b} )$$

$$Δ {E}_{b} = √ ( {( {L}_{c} - {L}_{b} )}^{2} + {( {a}_{c} - {a}_{b} )}^{2} + {( {b}_{c} - {b}_{b} )}^{2} )$$

$$Δ {E}_{a} = √ ( {( {L}_{c} - {L}_{a} )}^{2} + {( {a}_{c} - {a}_{a} )}^{2} + {( {b}_{c} - {b}_{a} )}^{2} )$$

Subscript ‘b’ denotes data for the stain before washing.
Subscript ‘a’ denotes data for the stain after washing.
Subscript ‘c’ denotes data for the unstained fabric.

The following test Examples in Table 5 are tested for cleaning, with result summarized in Table 5. The results suggest when delivered via particles of particle of Table 3, Inventive polymer 2 delivered surprisingly higher performance.

TABLE 5

| | Materials in wash pot | | | | |
|---|---|---|---|---|---|
| | Base | SRP added directly | SRP provided via | Cleaning | |
| Test | detergent | into wash solution | particle of Table 3 | SRI (Burnt | |
| samples | (ppm) | (ppm) ^{c} | (ppm) | butter) * | Difference |
| 1 | 1010 | 24 (Inventive | 0 | 83.1 DEF | +10.3 |
| | | polymer 2) | | | |
| 2 | 1010 | 0 | 24 (Inventive | 93.4 A | |
| | | | polymer 2) ^{a} | | |
| 3 | 1010 | 24 (comparative | 0 | 87.6 BCD | −5.1 |
| | | polymer 1) | | | |
| 4 | 1010 | 0 | 24 (comparative | 82.5 EF | |
| | | | polymer 1) ^{b} | | |

Washing condition: 17-minute wash cycle (temperature: 27 C.); 5-minute rinse cycle (temperature: 15 C.); 7-8gpg water hardness.
^{a} provided via Inventive Example 2 (Table 3).
^{b} provided via Comparative Example 1 (Table 3).
^{s} statically significant difference.
* Levels not connected by same letter are significantly different.
^{c} SRP is added via fresh prepared stock solution into wash pot, to avoid potential hydrolysis if formulated into base detergent.

The examples below are intended to illustrate the invention in detail without, however, limiting it thereto. Unless explicitly stated otherwise, all percentages given are percentages by weight (% by wt. or wt.-%, or wt. %).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

1. A fabric care product comprising a plurality of particles, wherein each particle of the plurality of particles comprises:
from 25% to 99%, by weight of the particle, a water-soluble carrier; and
from 1.0% to 75%, by weight of the particle, an anionic soil release polyester;
wherein the anionic soil release polyester comprises:
(i) at least one terephthalate structural unit,
(ii) at least one 5-sulfoisophthalate structural unit,
(iii) at least one alkylene glycol structural unit, and
(iv) at least one polyalkylene glycol structural unit,
wherein the weight percentage of polyalkylene glycol structural units (in relative to the anionic soil release polyester) is in the range from 35 to 95 wt. %, and
wherein the particle has a mass of from 5.0 mg to 1.0 g;
wherein the particle has a longest dimension of at least 3.0 mm; and
wherein the particle has an aspect ratio of from 1.1 to 5.0.

2. The fabric care product according to claim 1, wherein the weight percentage of polyalkylene glycol structural units (in relative to the anionic soil release polyester) is in the range from 55 to 90 wt. %.

3. The fabric care product according to claim 1, wherein the anionic soil release polyester comprises at least one terephthalate structural unit (A), at least one 5-sulfoisophthalate structural unit (B), at least one alkylene glycol structural unit (C), at least one first polyalkylene glycol structural unit (D), and optionally, if present at least one second polyalkylene glycol structural unit (E), 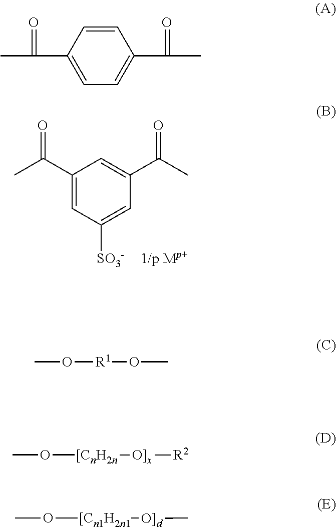
wherein
1/p M^{P+} is a cation, selected from the group consisting of H⁺, Li⁺, Na⁺, K⁺, ½Mg²⁺, ½Ca²⁺, ⅓Al³⁺, NH₄⁺ and R^{a}R^{b}R^{c}R^{d}N⁺, wherein R^{a}, R^{b}, R^{c} and R^{d}, independently of one another, are H, linear or branched (C₁-C₂₂)-alkyl groups or linear or branched (C₂-C₁₀)-hydroxyalkyl groups, and wherein in the cations R^{a}R^{b}R^{c}R^{d}N⁺ at least one of R^{a}, R^{b}, R^{c} and R^{d} is not H,
R¹ is a linear or branched alkylene group represented by the formula (CₘH₂ₘ) wherein m is an integer from 2 to 12,
R² is a linear or branched C₁-C₃₀ alkyl group, a cycloalkyl group with 5 to 9 carbon atoms or a C₆-C₃₀ arylalkyl group,
n is an integer from 2 to 12, whereby the definition of n may vary within a single structural unit (D),
x is, based on molar average, a number from 2 to 200,
n1 is an integer from 2 to 12, wherein, the definition of n1 may vary within a single structural unit (E),
d is, based on molar average, a number from 2 to 200,
wherein the total weight percentage of polyalkylene glycol structural units in structural unit (D) and/or (E) (in relative to the anionic soil release polyester) is in the range from 35 to 95 wt. %.

4. The fabric care product according to claim 3, wherein the anionic soil release polyester comprises one or more terephthalate structural units (A), one or more 5-sulfoisophthalate structural units (B), one or more alkylene glycol structural units (C), one or more first polyalkylene glycol structural units (D),
wherein in structural unit (C) and (D),
R¹ is a linear or branched alkylene group represented by the formula (CₘH₂ₘ) wherein m is an integer selected from 2 to 3,
x is, based on molar average, a number from 40 to 180.

5. The fabric care product according to claim 3, wherein the anionic soil release polyester comprises one or more terephthalate structural units (A), one or more 5-sulfoisophthalate structural units (B), one or more alkylene glycol structural units (C), one or more first polyalkylene glycol structural units (D),
wherein in structural unit (D)
x is, based on molar average, a number from 55 to 150.

6. The fabric care product according to claim 3, wherein the anionic soil release polyester comprises one or more terephthalate structural units (A), one or more 5-sulfoisophthalate structural units (B), one or more alkylene glycol structural units (C), one or more first polyalkylene glycol structural units (D), and one or more second polyalkylene glycol structural unit (E),
wherein in structural (E)
n1 is an integer from 2 to 4, wherein the definition of n1 may vary within a single structural unit (E)
d is, based on molar average, from 3 to 150.

7. The fabric care product according to claim 3, wherein the anionic soil release polyester comprises first polyalkylene glycol structural unit (D), wherein
R² is a linear C₁-C₆ alkyl group,
n is an integer from 2 to 4, and
x is, based on molar average, a number from 65 to 115.

8. The fabric care product according to claim 3, wherein the second polyalkylene glycol structural unit (E) of the anionic soil release polyester has a structure of formula (E-a) 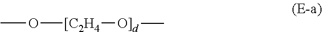
wherein d is, based on molar average, a number from 4 to 50.

9. The fabric care product according to claim 1, wherein the water-soluble carrier is selected from the group consisting of polyalkylene glycol, inorganic alkali metal salt, inorganic alkaline earth metal salt, organic alkali metal salt, organic alkaline earth metal salt, carbohydrates and derivatives thereof, clay, zeolites, citric acid, fatty alcohol, glycerol, glyceryl diester of hydrogenated tallow, water-soluble polymers, and combinations thereof.

10. The fabric care product according to claim 1, wherein the water-soluble carrier comprises polyethylene glycol having a weight average molecular weight from 2000 to 20000 Da.

11. The fabric care product according to claim 1, further comprising from 0.1 wt. % to 20.0 wt. %, of one or more perfume ingredients, wherein the perfume ingredients are selected from free perfumes, pro-perfumes, perfume capsules, and any combinations thereof.

12. The fabric care product according to claim 1, wherein the particle is present in the range from 0.1% to 100% by weight of the fabric care product.

13. The fabric care product according to claim 1, comprises from 0.1% to 99%, by weight of the fabric care product, of additional fabric care active agents.

14. A process for making the plurality of particles of claim 1, comprising the steps of:
providing a mixture of molten water-soluble carrier, an anionic soil release polyester, and optionally other materials;
cooling down the molten mixture on the moving conveyor to form a plurality of solid particles.
